(19) United States
(12) Patent Application Publication
(10) Pub. No.: US 2024/0126563 A1
(43) Pub. Date: Apr. 18, 2024

(54) Method of Parallel Implementation in Distributed Memory Architectures

(71) Applicant: The University of Liverpool, Liverpool Merseyside (GB)

(72) Inventors: Alessandro Varsi, Liverpool (GB); Simon Maskell, Liverpool (GB)

(21) Appl. No.: 18/274,835

(22) PCT Filed: Jan. 28, 2022
(86) PCT No.: PCT/GB2022/050238

§ 371 Date: Jul. 28, 2023

(30) Foreign Application Priority Data
Jan. 29, 2021 (GB) 2101274.5

(51) Int. Cl. G06F 9/445; G06F 7/08

(52) U.S. Cl. CPC G06F 9/44505; G06F 7/08

(57) ABSTRACT

The present techniques relate to a method for a parallel implementation of a sequential Monte Carlo (SMC) method of modelling an industrial process on a distributed memory architecture, and a system for implementing the same. The method may comprise receiving, from at least one sensor, a measurement of at least one parameter within the physical system, wherein the at least one parameter is related to the true state of the physical system; and implementing, on a server comprising a distributed memory architecture, a sequential Monte Carlo (SMC) process using a plurality of statistically independent particles and the at least one measured parameter to estimate the true state of the physical system, wherein the distributed memory architecture has a plurality of cores each of which are ranked. The method and architecture provide an efficient parallel implementation by effectively parallelising a redistribute step which may be considered to be a constituent part of a resampling step. The SMC method may be used to perform state estimation of dynamic or static models under non-linear, non-Gaussian noise.

### FIELD

The present techniques relates to a method for a parallel implementation of a sequential Monte Carlo method of modelling an industrial process on a distributed memory architecture, and a system for implementing the same.

### BACKGROUND

Sequential Monte Carlo (SMC) methods are a well-established family of algorithms to solve state estimation problems related to dynamic and static models, given a stream of data (i.e. measurements). The key idea is to employ a user-defined proposal distribution to draw N samples (i.e. particles) which approximate the probability density function of the state of the model. Then a correction step, called resampling, is used to correct the particle degeneracy that the sampling technique introduces. The application domain may be vast and diverse and may range, for example, from positioning [1] to medical research [2] [3], risk analysis [4], weather forecasting [5], financial econometrics [6] and broadly speaking any research or industrial field in which it is important to collect data and make predictions afterwards.

Modern applications of SMC methods have increasingly demanding accuracy and run-time constraints which can be met in several ways. For example, the number of particles could be increased [9] [10], or more sophisticated proposal distributions could be used as described in [7] or more measurements could be used if possible [8]. However, applying any of these solutions is likely to significantly slow down the run-time which could also become even more problematic if the constraint on the measurement rate is strict. An alternative solution to meet the run-time constraints without losing accuracy could be to employ parallel computing.

SMC methods are parallelisable, but it is not trivial to achieve an efficient parallelisation. The resampling step, which is necessary to respond to particle degeneracy [24], is indeed a challenging task to parallelise. This is due to the problems encountered in parallelising the constituent redistribute step whose textbook implementations achieve 0(N) time complexity on a single core.

On Shared Memory Architectures (SMAs), it has been proved that redistribute can achieve 0(log₂N) time complexity. Examples can be found in [9] to [12] for GPUs. However, High Performance Computing (HPC) applications need to use Distributed Memory Architectures (DMAs) to overcome the limitations in modern SMAs of low memory capacity and low degree of parallelism (DOP).

On DMAs, parallelization is more complicated as the cores cannot directly access the other cores' memory without exchanging messages. Three DMA solutions (along with mixed versions of them) are presented in [13], [14]: Centralized Resampling (C-R), Resampling with Proportional Allocation (RPA) and Resampling with Non Proportional Allocation (RNA). These approaches have been re-interpreted and improved several times, such as in [15]-[18]. In C-R, a central unit gathers the particles from all cores, performs redistribution and scatters the result back to the cores, making the communication increase linearly with degree of parallelism (DOP). RPA is randomised as redistribute is partly or potentially entirely centralized to a single or subset of master cores, leading to strongly non-deterministic data movement. In RNA, although the central unit is simpler than in RPA, after performing local resampling, particle exchange between neighbour cores is cyclically performed until redistribution is achieved, risking heavy redundant communication. In [18] to [20], it has been proved that such strategies have accuracy or stability issues, especially for unbalanced workload, large N or large DOP.

### SUMMARY

According to the present invention there is provided an apparatus and method as set forth in the appended claims. Other features of the invention will be apparent from the dependent claims, and the description which follows. We also describe a method for estimating a true state of a physical system, the method comprising receiving, from at least one sensor, a measurement of at least one parameter within the physical system, wherein the at least one parameter is related to the true state of the physical system; and implementing, on a server comprising a distributed memory architecture, a sequential Monte Carlo (SMC) process using a plurality of statistically independent particles and the at least one measured parameter to estimate the true state of the physical system, wherein the distributed memory architecture has a plurality of cores each of which are ranked. Implementing the SMC method may comprise determining the number of copies of particles required for each particle; and redistributing copies of particles which are to be duplicated across the distributed memory architecture. Redistributing includes moving the particles which are to be duplicated to the cores having lowest ranks to create gaps in the higher ranked cores using a rotational nearly sort process; when the rotational nearly sort process is complete, filling the gaps with the required number of copies of the particles which are to be duplicated using a rotational split process; and when the rotational split process is complete, filling the remaining gaps in each core using a sequential redistribute process. After redistributing, each of the plurality of cores only has copies of the particles which are to be duplicated and the total number of copies of each particle across the plurality of cores within the distributed memory architecture equals the determined number of copies.

We also describe an architecture for estimating a true state of a physical system, the architecture comprising at least one sensor for measuring at least one parameter within the physical system, wherein the at least one parameter is related to the true state of the physical system; and a server comprising a distributed memory architecture having a plurality of cores, wherein the cores are uniquely identified by a rank. The cores are configured to implement a sequential Monte Carlo (SMC) process on the distributed memory architecture using a plurality of statistically independent particles to estimate the true state of the physical system using the at least one measured parameter. Implementing the SMC process by the cores may comprise determining the number of copies of particles required for each particle; and redistributing copies of particles which are to be duplicated across the distributed memory architecture. Redistributing includes moving the particles which are to be duplicated to the cores having lowest ranks to create gaps in the higher ranked cores using a rotational nearly sort process; when the rotational nearly sort process is complete, filling the gaps with the required number of copies of the particles which are to be duplicated using a rotational split process; and when the rotational split process is complete, filling the remaining gaps in each core using a sequential redistribute process. After redistributing, each of the plurality of cores only has copies of the particles which are to be duplicated and the total number of copies of each particle across the plurality of cores within the distributed memory architecture equals the determined number of copies.

The above method and architecture provide an efficient parallel implementation by effectively parallelising the redistribute step which may be considered to be a constituent part of a resampling step. The SMC method may be used to perform state estimation of dynamic or static models under non-linear, non-Gaussian noise. The plurality of particles may be termed hypotheses or samples and may be generated at every step. The plurality of particles may be sampled from a user-defined proposal distribution such that each particle represents the probability density function (pdf) of the true state of the physical system. Each particle may be assigned to a weight such that the weights provide information on which particle best describes the real state of the physical system.

The following features may apply to the method and the architecture.

The number of particles (N) may be a power of two. Similarly, the number of cores (P) may be a power of two. Each core may own n=N/P elements.

The rotational nearly sort process may be described as a process which ensures that the particles which are to be duplicated are separated from those which are not to be duplicated. The particles which are not to be duplicated are considered empty spaces (or gaps, the terms may be used interchangeably) which can be substituted with copies of the particles which are to be duplicated. Moving the particles using the rotational nearly sort process may comprise determining, for each particle to be duplicated, the number of particles in lower ranked cores which are not to be duplicated; and obtaining, for each particle to be duplicated, an associated binary expression of the number of particles which are not to be duplicated. Determining the number of particles not to be duplicated may be considered as counting the zeros that each of the particles can see in the lower ranked cores. The number of zeros may be considered as the number of positions to shift by down into the lower ranked cores. Shifting may be shifting to a lower ranked core and also where the core contains more than one particle, i.e. more than one partition, shifting to a lower partition within a core.

Moving the particles which are to be duplicated may be an iterative process. The iterative process may comprise scanning, for each of the particles to be duplicated, a bit of the associated binary expression; rotating based on the scanned bit and repeating in sequence the scanning and rotating steps for each bit. When the scanned bit is equal to one, the associated particle may be rotated to a lower ranked core. When the scanned bit is equal to zero, the associated particle may not be rotated (or shifted, the terms are used interchangeably, as well as related nouns such as shifts and rotations). A least significant bit of each binary expression may be scanned first. Then each of the adjacent bits may be scanned in sequence. Finally, a most significant bit of each binary expression may be scanned.

There may be an optional leaf shift stage if the number of cores (P) is fewer than the number of particles (N). The leaf shift stage may be performed before the scanning and rotating steps. In the leaf shift stage, a core may transfer all the particles to a neighbouring core.

The goal of the rotational split phase is to fill the gaps in a way that balances the workload across the cores. This can be achieved by making enough room between the particles that have to be copied and creating the copies in these new empty spaces. While these two steps could be performed one after another, here it is shown that it is possible to perform both at the same time.

Filling the gaps using the rotational split process may comprise computing a minimum shift value for each of the particles to be duplicated and computing a maximum shift value for each of the particles to be duplicated. The minimum shift value may be a value representing the minimum number of shifts each of the particles must take to securely distance itself from the particles in the lower ranked cores; and the maximum shift value may be a value representing the maximum number of shifts each of the particles may take to end up in a gap.

Computing the minimum shift value associated with a particle to be duplicated may comprise summing for each lower ranked core one less than the number of copies which are required of each particle in the lower ranked cores. Computing the maximum shift value associated with a particle to be duplicated may comprise summing the minimum shift value with one less than the number of copies which are required of the associated particle. The calculations may be:

min_shiftsⁱ=Σⱼ₌₀ⁱ⁻¹(ncopies^{j}−1)=csumⁱ−ncopiesⁱ−i

max_shiftsⁱ=min_shiftsⁱ+ncopiesⁱ−1=csumⁱ−i−1

where ncopiesⁱ is the number of copies which is required for each particle, and csumⁱ is the inclusive cumulative sum over ncopies up to the i^{th} element. More details are provided below.

For each particle to be duplicated, an associated binary expression of the minimum shift value and the maximum shift value may be obtained. Creating the gaps may be an iterative process comprising scanning and rotating steps which are repeated. For each of the particles to be duplicated, a bit of the associated binary expression of the minimum shift value and the maximum shift value may be scanned. When both scanned bits are equal to one, the associated particle may be rotated to a higher ranked core by a number of positions corresponding to the scanned bits. When only one scanned bit is equal to zero, the number of copies to be duplicated may be split to determine excess duplicates and the excess duplicates may be rotated to a higher ranked core by a number of positions corresponding to the scanned bits. When no scanned bit is equal to one, there is no rotation. The rotation may be determined by the bit which is scanned, for example particles are rotated by decreasing power of two numbers of bit position.

The scanning may be in the opposite direction to the scanning in the rotational nearly sort process. A most significant bit of each binary expression may be scanned first. Then each of the adjacent bits may be scanned in sequence. Finally, a least significant bit of each binary expression may be scanned.

There may be an optional leaf shift stage if the number of cores (P) is fewer than the number of particles (N). The leaf shift stage may be performed after a certain number of scanning and rotating steps.

The goal of the sequential redistribute phase is to fill the remaining gaps in each core which are not filled by the rotational split phase. Filling the remaining gaps in each core using a sequential redistribute process may comprise duplicating particles within the memory of each core.

The SMC method may further comprise obtaining values for each of the particles; computing weights for each of the particles, wherein the weight indicates the resemblance of the obtained values to the true state; normalising the computed weights; determining the number of copies which are required based on the normalised weights; and after redistributing the particles, resetting the weights. The obtaining, computing, normalising, determining, redistributing, and resetting steps may be repeated at each iteration. The values for the each of the particles may be obtained from the proposal distribution. This step, along with computing weights for each of the particles, may be termed importance sampling (IS). Determining the number of copies ncopiesⁱ required for each particle i may be computed from:

ncopiesⁱ=┌cdfⁱ⁺¹−u┐−┌cdfⁱ−u┐

where cdfⁱ is the cumulative density function of the weights up to and including the i^{th} particle and u is drawn from a uniform distribution with u˜[0,1). The bracket operator is the ceiling function which rounds up the input number to the next integer, unless the input number is an integer already in which case the output of the ceiling function is identical to the input.

There are various embodiments of the SMC process. For example, the SMC process may be selected from a particle filter, a fixed-lag SMC sampler and an SMC sampler. For particle filters, there may be one measurement per iteration and resampling is typically only used if needed. For SMC samplers, there may be only one measurement which is collected, and the iterations are run given the same measurement. The method finalises estimates with recycling and resampling is used only if needed. For fixed-lag SMC, a history of l>1 measurements may be used at each iteration (where l is the lag). The method samples and resamples trajectories of l>1 particles.

For a particle filter, the weight may be calculated from:

$${w}_{t}^{i} = {w}_{t - 1}^{i} \frac{p ( {x}_{t}^{i} , {Y}_{t} \vert {x}_{t - 1}^{i} )}{q ( {x}_{t}^{i} \vert {x}_{t - 1}^{i} , {Y}_{t} )}$$

where wₜⁱ and wₜ₋₁ⁱ are the weights for time steps t and t−1, xₜⁱ and xₜ₋₁ⁱ are the values of the particles for time steps t and t−1, p(xₜⁱ, Yₜ|xₜ₋₁ⁱ) is the incremental posterior, commonly called target or posterior distribution, q( )is the proposal distribution defined by the user, and Yₜ is a measurement of the system collected at time t. For an SMC sampler, the weight may be calculated from:

$${w}_{t}^{i} = {w}_{t - 1}^{i} \frac{p ( {x}_{t}^{i} \vert {Y}_{t} ) L ( {x}_{t - 1}^{i} \vert {x}_{t}^{i} )}{p ( {x}_{t - 1}^{i} \vert {Y}_{t} ) q ( {x}_{t}^{i} \vert {x}_{t - 1}^{i} , {Y}_{t} )}$$

where wₜⁱ and wₜ₋₁ⁱ are the weights for iterations t and t−1, xₜⁱ and xₜ₋₁ⁱ are the values of the particles for iterations t and t−1, p(xₜⁱ|Yₜ) is the pdf of the state, q( )is the proposal distribution defined by the user, Yₜ is the measurement of the system used in every iteration and L( ) is a user defined backward kernel.

For a fixed-lag SMC sampler, a new measurement may be collected from the at least one sensor but the previous l measurements may also be used. The weight may be calculated from:

$${w}_{t}^{i} = {w}_{t - 1}^{i} \frac{p ( {x}_{t - l : t}^{i} , {Y}_{t - l : t} \vert {\overline{x}}_{t - l - 1}^{i} ) L ( {\overline{x}}_{t - l - 1 : t - 1}^{i} \vert {x}_{t - l : t - 1}^{i} )}{p ( {\overline{x}}_{t - l : t - 1}^{i} , {Y}_{t - l : t - 1} \vert {\overline{x}}_{t - l - 1}^{i} ) q ( {x}_{t - l : t}^{i} \vert {\overline{x}}_{t - l - 1 : t - 1}^{i} , {Y}_{t - l : t} )}$$

where wₜⁱ and wₜ₋₁ⁱ are the weights for time steps t and t−1, x̅_{t-l-1:t-1}ⁱ are the sampled particles from the old trajectories, x_{t-l:t}ⁱ are the sampled particles for the new trajectories, l is the lag, the p( ) terms are posterior for the new and the old trajectories, q( ) is the proposal distribution defined by the user, Y_{t-l:t} is the set of previously collected measurements of the system and L( ) is a user defined backward kernel.

We also describe a (non-transitory) computer readable medium carrying processor control code which when implemented in a system causes the system to carry out the method described above.

Although a few preferred embodiments of the present invention have been shown and described, it will be appreciated by those skilled in the art that various changes and modifications might be made without departing from the scope of the invention, as defined in the appended claims.

### BRIEF DESCRIPTION OF DRAWINGS

For a better understanding of the present techniques, and to show how embodiments of the same may be carried into effect, reference will now be made, by way of example only, to the accompanying diagrammatic drawings in which:

FIG. 1a is a schematic illustration of an infrastructure comprising a distributed memory architecture;

FIG. 1b is a schematic illustration of the server layer of FIG. 1a;

FIG. 2a is a flowchart of a method of implementing the SMC module of the system of FIG. 1b;

FIG. 2b is a schematic illustration of the steps in a reduction algorithm which is used to calculate sum;

FIG. 3 is a schematic illustration of the redistribute step in the method shown in FIG. 2a;

FIG. 4 is a flowchart of the steps within the rotational nearly sort phase of FIG. 3;

FIG. 5a is a schematic illustration of the rotational nearly sort algorithm of FIG. 4;

FIG. 5b is a schematic illustration of inclusive/exclusive cumulative sum phase which is used in the rotational nearly sort algorithm of FIG. 4;

FIG. 6 is a flowchart of the steps within the rotational split phase of FIG. 3;

FIG. 7 is a schematic illustration of the rotational split algorithm of FIG. 6 along with the final sequential redistribute phase;

FIG. 8a plots, for N=2¹⁶ and M=1 (where M is the particle dimension), the run-time of the redistribute phase of the overall algorithm of FIG. 2a against increasing numbers of cores (P) comparing the results for the new RoSS method shown in FIG. 3 with two prior art methods labelled B-R and N-R;

FIGS. 8b and 8c, like FIG. 8a, plot the comparative run-time of the redistribute phase for the new method and prior art methods against increasing numbers of cores (P) for N=2²⁰ and for N=2²⁴, respectively;

FIG. 8d plots the run-time of the redistribute phase for the new method and prior art method N-R against increasing numbers of cores (P) for N=2²⁴ with measured results shown for P<256 and expected results shown for P>256;

FIGS. 9a to 9c plot the run-time of the overall implementation in a real-world example of the particle filter against increasing numbers of cores (P) comparing the results which incorporate the new RoSS method for the redistribute phase with two prior art methods labelled B-R and N-R, the number of particles increases for each of FIGS. 9a to 9c;

FIG. 9d plots the run-time of the particle filter for the new method and prior art method N-R against increasing numbers of cores (P) for N=2²⁴ with measured results shown for P<256 and expected results shown for P>256;

FIG. 10a shows the workload percentage for each phase of the overall algorithm as it changes with increasing number of cores (P) for the real-world example and compares the results which incorporate the new RoSS method for the redistribute phase with two prior art methods labelled B-R and N-R;

FIG. 10b shows the workload percentage for each phase of the overall algorithm as it changes with increasing number of cores (P) for a second real-world example, in this case using an SMC sampler, and compares the results which incorporate the new RoSS method for the redistribute phase with two prior art methods labelled B-R and N-R.

FIGS. 11a to 11c plot the run-time of the overall implementation in the real-world example of the SMC sampler against increasing numbers of cores (P) comparing the results which incorporate the new RoSS method for the redistribute phase with two prior art methods labelled B-R and N-R, the number of particles increases for each of FIGS. 11a to 11c; and

FIG. 11d plots the run-time of the SMC sampler for the new method and prior art method N-R against increasing numbers of cores (P) for N=2²⁴ with measured results shown for P<256 and expected results shown for P>256.

### DETAILED DESCRIPTION OF DRAWINGS

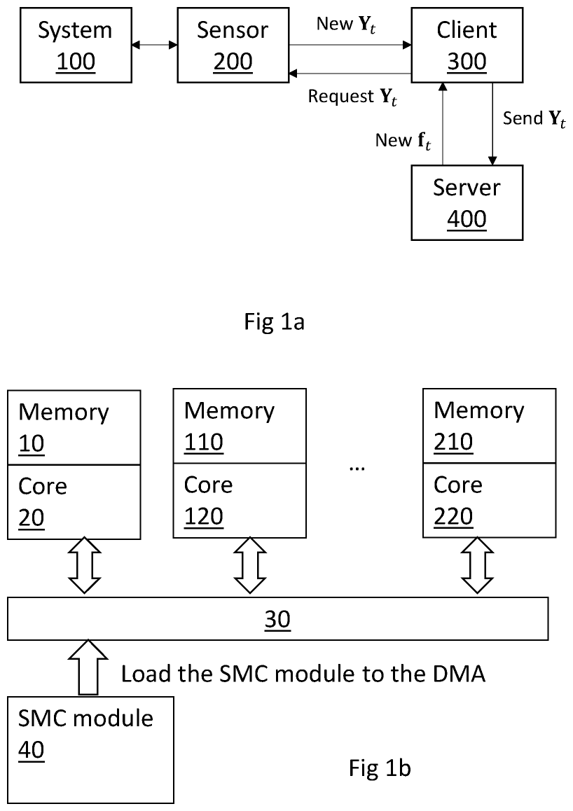

FIG. 1a schematically illustrates an architecture for implementing the present techniques. The infrastructure comprises four separate layers: the system layer 100, the sensor layer 200, the client layer 300 and the server layer 400. The system layer 100 comprises the physical system which is to be modelled, i.e. the system for which the true state Xₜ is to be estimated. As explained in more detail below, the estimate is obtained using an SMC method which requires a measurement Yₜ which is somehow related to the true state Xₜ. The measurement Yₜ is obtained by the sensors in the sensor layer. The sensor layer 200 comprises at least one sensor for measuring parameters of the system to estimate the true state. The sensors may be wireless, including satellites, may be embedded within the physical system or connected by cables.

The client layer 300 may comprise any suitable client device, e.g. a laptop or desktop PC, which may monitor the estimate fₜ of the state. The client layer 300 is connected both to the sensors, e.g. via an antenna or other wireless connection and to the server layer 400. The server layer 400 may be remote from the client layer 300 (i.e. in a different location). As shown, the client layer may request the new measurements from the sensor layer 200 and receive the new measurements from the sensor layer 200. The client layer 300 may then send the received measurements to the server layer 400 together with a model of the physical system 100. In other words, the client layer has two roles: the first is to request and collect the measurements and pass to the server; the second is to receive a new estimate of the state fₜ from the server such that it can be printed out for the users. The user may be an engineer who designs the model, i.e. a source code describing Xₜ, Yₜ, the proposal, the target, the initial distributions and the backward kernel L( ).

The server layer 400 may be a supercomputer on which parallel methods may be installed and run. The server layer 400 may be a high performance computing machine comprising hardware cores (or processors, the terms may be used interchangeably) connected via ethernet cables or Infiniband. In particular, the server layer 400 may run an SMC method as described in more detail below. At each iteration, the server waits for the client to send a new measurement and then runs a full SMC iteration (i.e. IS, normalise, ESS, MVR, redistribute, reset and estimate in sequence) to produce a new estimate fₜ and send it back to the client. All parallelisation methods (including the one for redistribute which is the focus of the method described below) are installed in the server, since they parallelise tasks which are fully compatible with any model.

The client layer must also send the model to the server and compile it with the rest of the SMC method components to generate the executable file. A job request may then be submitted to the server such that the process can start. For example, a job request may be done by submitting a bash file, containing the path to the executable file, the number of cores and the memory to be allocated and other required inputs such as N, N*, T_{SMC}, l and variant which are described in more detail below.

Further details of the server layer are shown in FIG. 1b. The server comprises a distributed memory architecture (DMA) executing an SMC module 40. DMAs are a type of parallel system which are inherently different from SMAs. The DMA comprises a plurality of memory blocks 10, 110, 210 and a plurality of discrete cores 20, 120, 220, connected via a common communication network 30. Three memory blocks and associated cores is merely illustrative. In this environment, the memory is distributed over the cores and each core 20, 120, 220 can only directly access its own private memory 10, 110, 210. Exchange of information stored in the memory of the other cores is achieved by sending or receiving explicit messages through a common communication network 30.

The main advantages of a DMA relative to an SMA include larger memory and number of cores, scalable memory and computation capability with the number of cores and a guarantee of there being no interference when a core accesses its own memory. The main disadvantages are the cost of communication and the consequent data movement. This may affect the speed-up relative to a single core.

In order to implement the methods (or algorithms, the terms are used interchangeably) discussed below, a Message Passing Interface (MPI) may be used. MPI is one of the most common application programming interfaces (APIs) for DMAs. In this model, the total number of cores is represented by P and each core is uniquely identified by a rank p=0, 1, . . . , P−1. The cores are connected via communicators and use send or receive communication routines to exchange messages.

In this arrangement, the SMC module 40 may be distributed across multiple components. The SMC module implements a sequential Monte Carlo method and may be used to perform state estimation of dynamic or static models under non-linear, non-Gaussian noise. There are a range of different implementations of SMC methods, including sequential importance resampling (SIR) particle filters. SMC methods apply the importance sampling principle to make Bayesian inferences.

The general idea of SMC methods consists of generating N statistically independent hypotheses called particles or samples at every step t. The population of particles (or samples) xₜ is sampled from a user-defined proposal distribution q(xₜⁱ|xₜ₋₁ⁱ, Yₜ) such that xₜ represents the probability density function (pdf) of the state of a model. Each particle xₜⁱ is then assigned to an unnormalized weight wₜⁱ such that the array of weights provides information on which particle best describes the real state of interest. Thus, we have:

xₜ∈ [symbol] ^{N×M}

wₜⁱ=f(wₜ₋₁ⁱ, xₜⁱ, xₜ₋₁ⁱ, Yₜ)

wₜ∈ [symbol] ^{N}

As explained below, the methods implemented on this system use the divide-and-conquer paradigm and therefore there are always a power of two number of cores to balance the communication between them. For the same reason, the number of particles N will also be always a power of two number such that the particles x t and every array related to them, e.g. the weights wₜ will be equally spread amongst the cores. This means that every core will always own exactly n=N/P elements of all the listed arrays whose indexes will be spread over the cores in increasing order. More precisely, given a certain N, P pair the i^{th} particle (where 0≤i≤N−1) will always be given to the same core with MPI rank p=int(i/n). The space complexity is then 0(1) when P=N.

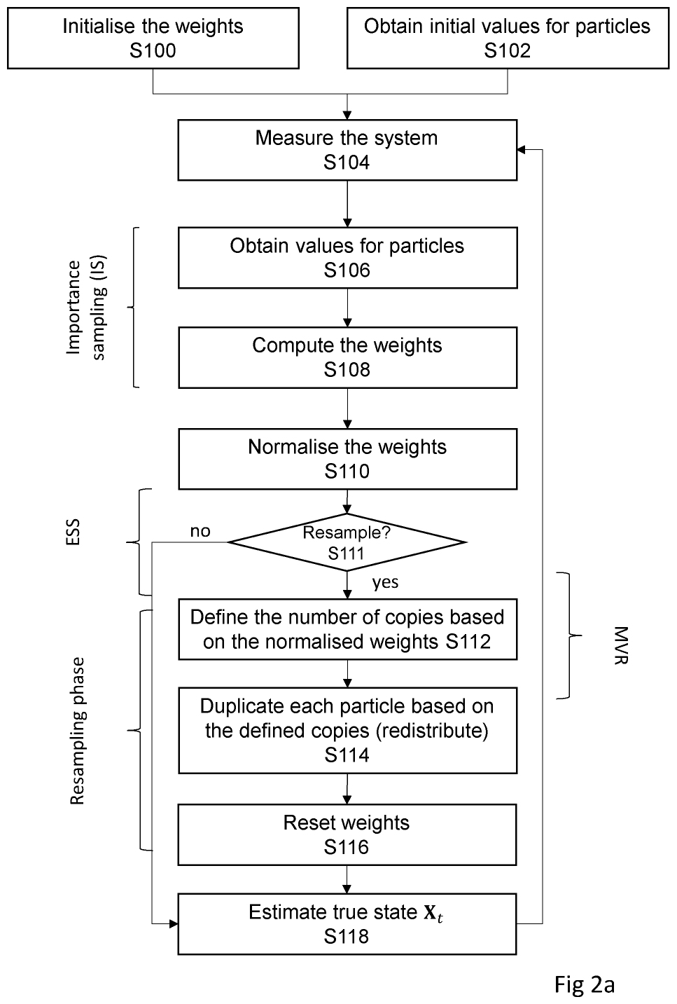

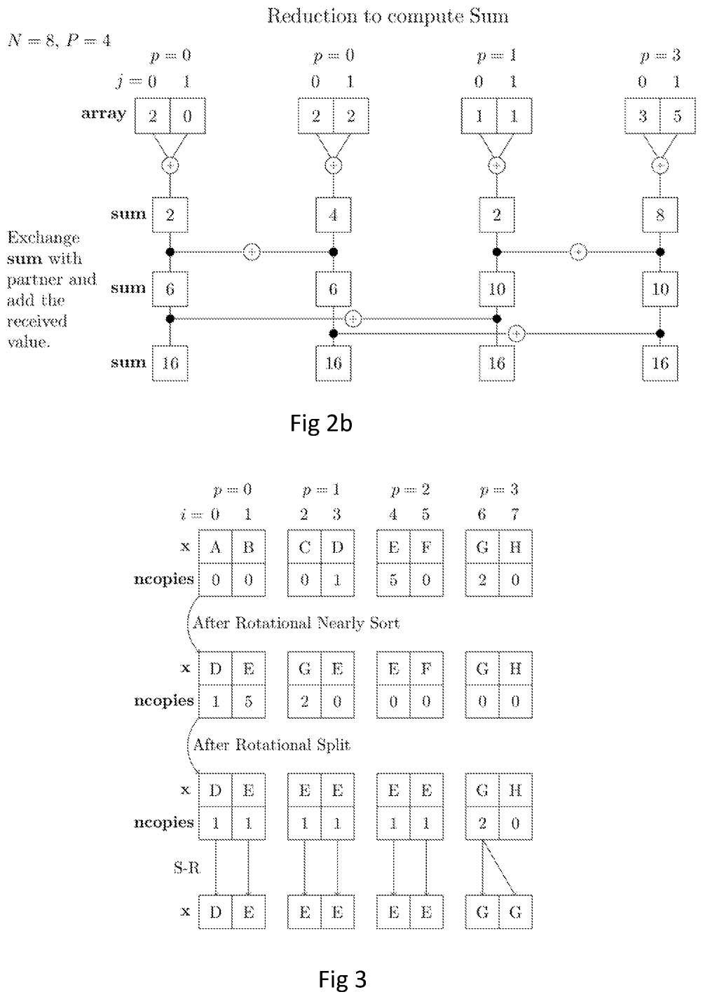

FIG. 2a is a flowchart illustrating the method of implementing an SMC method on the DMA. As set out above, the SMC method generates N statistically independent hypotheses called particles (or samples) xₜ at every given iteration t. As shown in FIG. 2a, the aim of the final step S118 is to estimate the current true state Xₜ of the dynamic or static system. As explained in more detail below, in the case of SMC samplers only, the estimate is improved by performing a recycling step. Therefore, for brevity, S118 represents the actual estimate operation (which is required in any SMC method) followed by recycling if required. Since the particles (which are possible inferences of the true state) are weighted based on their resemblance with Xₜ, feedback from the system is required to correctly assign a weight to each particle. The initial steps include initialising the weights S100 and obtaining initial values for the particles S102. These two steps may be performed in any order. After that, the SMC iterations start by measuring the system S104 as indicated in FIG. 2a. As described in detail below, particle filters and fixed-lag SMC samplers collect a new measurement at every iteration, while the SMC samplers simply use the first measurement at all iterations. Therefore, for brevity, S104 is intended to represent generically the measurement strategy of any SMC method. The measurement provides the feedback from the system and at every iteration t a new measurement Yₜ may be collected. Yₜ must be some measurable physical quantity which is either part of Xₜ itself or related to Xₜ by some physical law.

At the initial iteration t=0, no measurement has been collected yet, so Initialising the weights may be done by setting each weight to the same value. The prior data Y₀ may be given and the initial values for the particles may be initially drawn from the initial distribution because this is the best assumption without feedback, thus we have

$${X}_{t} ∈ {ℝ}^{M}$$

$${Y}_{t} ∈ {ℝ}^{D}$$

$${w}_{0}^{i} = \frac{1}{N} , i ∈ 0 … N - 1$$

$${q}_{0} ( {x}_{0} ) = {p}_{0} ( {x}_{0} \vert {Y}_{0} )$$

where Xₜ is the current true state of the system, M is the dimension of the state, Yₜ is a measurement of the system sent to the server at iteration t, D is the dimension of the measurement, w₀ⁱ is the weight at iteration t=0 to be applied to each particle x₀ⁱ, N is the number of particles, q₀( ) is the initial proposal distribution defined by the user.

Once the initial values are obtained and for any iteration t>0 measurements may be collected and the values for the particles may be drawn from the proposal distribution (step S106), for example as defined in equation (1). This phase along with the weighting procedure in equation (2) may be termed importance sampling (IS).

xₜⁱ˜q(xₜⁱ|xₜ₋₁ⁱ, Yₜ) (1)

The obtained weights may then be computed as a function of xₜⁱ, xₜ₋₁ⁱ, wₜ₋₁ⁱ, Yₜ, and normalised (steps S108 and S110), for example as defined in equations (2) and (3).

$${w}_{t}^{i} = f ( {x}_{t}^{i} , {x}_{t - 1}^{i} , {w}_{t - 1}^{i} , {Y}_{t} ) \qquad ( 2 )$$

$${\tilde{w}}_{t}^{i} = \frac{{w}_{t}^{i}}{{\sum }_{j = 0}^{N - 1} ( {w}_{t}^{j} )} \qquad ( 3 )$$

where xₜⁱ is a particle at iteration t, q is the proposal distribution defined by the user, Yₜ is a measurement of the system, wₜⁱ is the weight of the i^{th} particle at iteration t, \tilde{w}ₜⁱ is the normalised weight of the i^{th} particle at iteration t and N is the number of particles. Equation (3) thus represents a normalise step and is used because the weights need to sum up to 1.0 (i.e. 100% of all probabilities), just like any pdf does.

The particles may be subject to a phenomenon called degeneracy which (within a few iterations) make all weights but one decrease towards 0. This is because the variance of the weights is proven to increase at every iteration as described in [24]. This is addressed by a resampling phase which may be considered to repopulate the particles by eliminating the most negligible ones and duplicating the most important ones. This resampling phase may not always be triggered and for example may be only triggered when needed, e.g. when the (approximate) effective sample size N_{eff} is below a threshold N* (e.g. N/2). There is thus a decision at step S111 as to whether resampling is required, and this requires a computation of the effective sample size (ESS) and is defined by

$${N}_{eff} = \frac{1}{{\sum }_{i = 0}^{N - 1} {( {\tilde{w}}_{t}^{i} )}^{2}} < {N}^{*} \qquad ( 4 )$$

In some cases, the user may purposely decide to perform resampling always. This can be done by setting N*=N+1. In this case, SMC is typically found in the literature under the name of Bootstrap Filter. Several (biased or unbiased) resampling schemes exist [25], [26] but they all repopulate the particles in three steps.

When it is determined that resampling is required, the first step (step S112) of the resampling may be to define the number of copies of the i^{th} particle which are required (ncopiesⁱ). Various techniques may be used to generate ncopiesⁱ but regardless of the method of generation, the following statements are true:

Σᵢ₌₀^{N-1}ncopiesⁱ=N (5)

ncopies∈ [symbol] ^{N}

E[ncopiesⁱ]=N\tilde{w}ₜⁱ

0≤ncopiesⁱ≤N∀i

One method of performing this step is Systematic Resampling, as described in [25], but is also termed Minimum Variance Resampling (MVR) in several referenced works, e.g. [12], [19], and [21]-[23]. The key idea of MVR is to first compute the cumulative density function (CDF) of \tilde{w}ₜ, then draw u˜[0,1) from a uniform distribution and finally compute each ncopiesⁱ as follows:

ncopiesⁱ=┌cdfⁱ⁺¹−u┐−┌cdfⁱ−u┐ (6)

The bracket operator is the ceiling function which rounds up the input number to the next integer, unless the input number is an integer already.

Once the number of copies is determined, the second step of resampling is a redistribute step (S114) in which each particle xₜⁱ is duplicated as many times as ncopiesⁱ. The detail of the redistribute step is described in more detail below. The final step of resampling is to reset all the weights to the initial value (i.e. 1/N).

After resampling, every iteration in the SMC method is completed by making an estimate fₜ of the true state Xₜ by computing the mean of the particles xₜ as follows:

$${f}_{t} = \frac{1}{N} {\sum }_{i = 0}^{N - 1} {x}_{t}^{i} \qquad ( 7 )$$

This procedure goes on for T_{SMC} SMC iterations.

There are various embodiments of SMC which may be used, and three variants are described in detail below. The main difference between each variant is the equation defining the weights—equation (2) above.

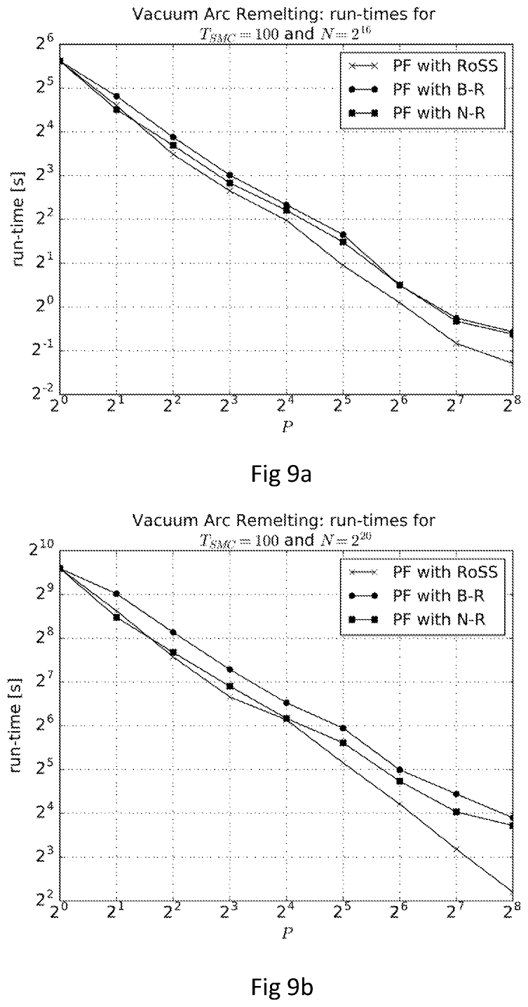

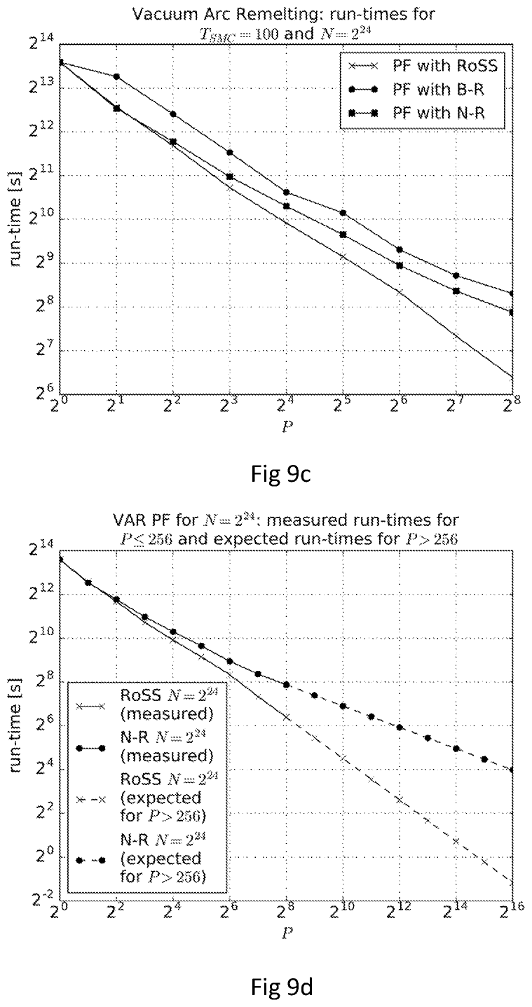

Particle filters (PFs) are described for example in and are SMC methods that work well on dynamic models, which are typically used in real-time contexts where the true state changes frequently. In the PF, the SMC iterations are commonly called time steps. A new measurement Yₜ is available at each time step and thus the client and sensor layers of FIG. 1a communicate frequently. For example, if we are interested in using particle filters to predict the traffic level over time in a busy city, the sensors, e.g. satellites may obtain the positions of vehicles (see [27]). Another example could be an application of particles filters to estimate the state of a power system for security purposes which requires cabled sensors to measure the voltage of generators (see [28]). The description below in relation to FIGS. 9a to 9d show the results of a particle filter estimating the state of a vacuum arc remelting device for alloy production.

In this SMC variant the weight equation is:

$${w}_{t}^{i} = {w}_{t - 1}^{i} \frac{p ( {x}_{t}^{i} , {Y}_{t} \vert {x}_{t - 1}^{i} )}{q ( {x}_{t}^{i} \vert {x}_{t - 1}^{i} , {Y}_{t} )} \qquad ( 8 )$$

where the p( ) term, commonly called target or posterior distribution, is computed as the product of p(xₜⁱ|xₜ₋₁ⁱ), the prior distribution, and p(Yₜ|xₜⁱ), the likelihood distribution. Thus, the weight equation may be expressed as:

$${w}_{t}^{i} = {w}_{t - 1}^{i} \frac{p ( {x}_{t}^{i} \vert {x}_{t - 1}^{i} ) p ( {Y}_{t} \vert {x}_{t}^{i} )}{q ( {x}_{t}^{i} \vert {x}_{t - 1}^{i} , {Y}_{t} )}$$

where xₜⁱ and xₜ₋₁ⁱ are particles at time t and t−1, q( ) is the proposal distribution defined by the user, Yₜ is a measurement of the dynamic system collected at time t, wₜⁱ and wₜ₋₁ⁱ are the weights of the i^{th} particle at time t and t−1.

Particle filters typically work well when the sensor layer always provides low-latency measurements. However, that is not always possible due to time delays in the external environment. Fixed-lag (FL) SMC such as described in [29] are usually used rather than particle filters in this scenario. In FL SMC, a new measurement Yₜ is collected from the sensors and sent to the server. However, the server will also keep in memory, the previous l measurements Y_{t-l:t-1}, where l is commonly called lag. Hence l+1 measurements Y_{t-l:t} are considered every time, such that the filter can retrospectively reprocess the previous measurements in light of that most recently received. Therefore, instead of sampling N particles xₜⁱ, FL SMC samples N trajectories of l+1 particles x_{t-l:t}ⁱ from the old trajectories as follows:

x_{t-l:t}ⁱ˜q(x_{t-l:t}ⁱ|x̅_{t-l-1:t-1}ⁱ, Y_{t-l:t}) (9)

where x̅_{t-l-1:t-1} are the old trajectories.

Particles filters may be intuitively viewed as FL SMC with l=0. Therefore, the equation above can be substituted in the generic algorithm which is installed in the server. Depending on the chosen SMC variant, l is automatically set to 0 to work in a general-purpose way. The particle trajectories are weighted by the following equation which defines the weights:

$${w}_{t}^{i} = {w}_{t - 1}^{i} \frac{p ( {x}_{t - l : t}^{i} , {Y}_{t - l : t} \vert {\overline{x}}_{t - l - 1}^{i} ) L ( {\overline{x}}_{t - l - 1 : t - 1}^{i} \vert {x}_{t - l : t - 1}^{i} )}{p ( {\overline{x}}_{t - l : t - 1}^{i} , {Y}_{t - l : t - 1} \vert {\overline{x}}_{t - l - 1}^{i} ) q ( {x}_{t - l : t}^{i} \vert {\overline{x}}_{t - l - 1 : t - 1}^{i} , {Y}_{t - l : t} )} \qquad ( 10 )$$

where L(x̅_{t-l-1:t-1}ⁱ|x_{t-l:t-1}ⁱ) is a user defined backward kernel, which describes the correlation between the old trajectory and the new trajectory. Here the p( ) terms can also be expressed as likelihood-prior products as for the particle filter, but here it is omitted for brevity.

SMC samplers as described in [30] work well on static models, hence those scenarios where the true state is assumed to be constant for a considerably large amount of time, such that very frequent measurements (e.g. every few seconds as in real-time applications) will not lead to a significantly different state estimation. SMC samplers then collect a single measurement at t=1. During the SMC iterations, the same data is re-proposed to the server by the client and each new estimate fₜ is simply a more accurate state estimate than it was in the previous SMC step. In other words, one can think of SMC samplers as particle filters which are specialised in maximising the state estimation accuracy given a single measurement, which requires lots of computation and hence is only practical if the application is off-line. Here the weight equation is calculated as follows:

$${w}_{t}^{i} = {w}_{t - 1}^{i} \frac{p ( {x}_{t}^{i} \vert {Y}_{t} ) L ( {x}_{t - 1}^{i} \vert {X}_{t}^{i} )}{p ( {x}_{t - 1}^{i} \vert {Y}_{t} ) q ( {x}_{t}^{i} \vert {x}_{t - 1}^{i} , {Y}_{t} )} \qquad ( 11 )$$

Once again, the p( ) terms can also be expressed as likelihood-prior products as for the PF, but here it is omitted for brevity. After the SMC iterations, SMC samplers optimise each state estimate, fₜ, such that, at the t^{th} iteration, the output takes the following value:

$${f}_{t}^{new} = \frac{nsum}{dsum} = \frac{{\sum }_{τ = 1}^{t} {f}_{τ} {c}_{τ}}{{\sum }_{τ = 1}^{t} {c}_{τ}} \qquad ( 12 )$$

where the normalisation constants c_{τ} may be computed as follows:

$${c}_{τ} = \frac{{\sum }_{i = 0}^{N - 1} {w}_{τ}^{i}}{{\sum }_{i = 0}^{N - 1} {w}_{τ - 1}^{i}} \qquad ( 13 )$$

This optimisation technique is called recycling and was first proposed in the context of SMC samplers in [31]. To be efficient, this operation is computed recursively at each SMC iteration, i.e. by updating step by step its numerator, nsum, and denominator, dsum, otherwise it would require the cores holding a lot of state information.

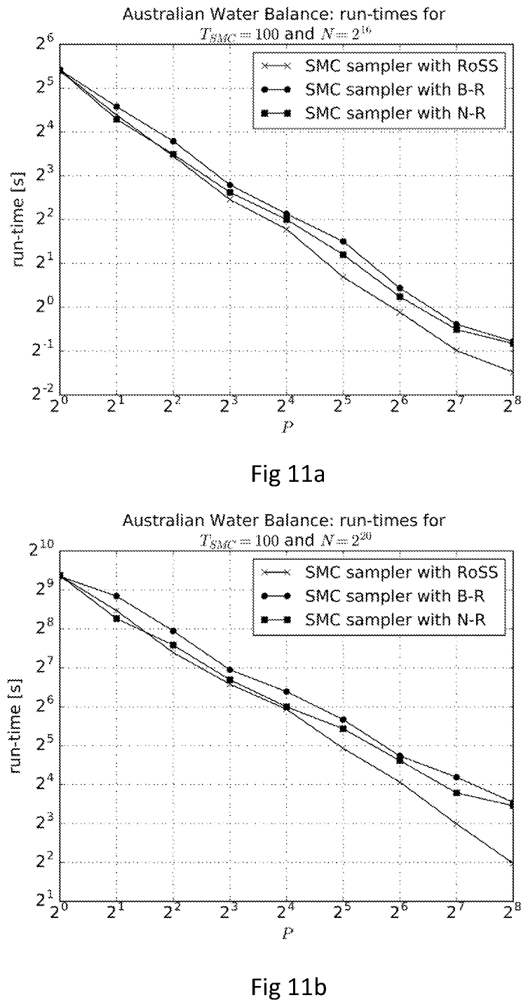

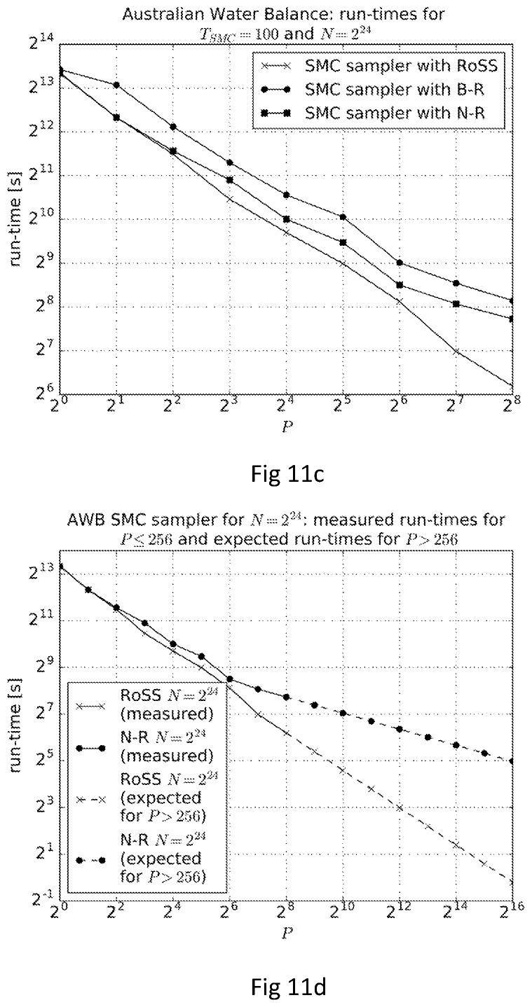

SMC samplers find application in several domains, such as parameter tuning for system design or medical applications for disease diagnosis [32], [33], where the state is assumed to be constant on the testing day. The description below in relation to FIGS. 11a to 11d show the results of an SMC sampler estimating the water runoff levels in a hydraulic system.

The following is an example of the pseudo code for an algorithm which may be used to implement the SMC method described in FIG. 2a:

Algorithm 1 - Sequential Monte Carlo
Input: T_{SMC}, N, N*, l, variant, model
Output: fₜ

| | |
|---|---|
| 1: | Y₀ ← Initialise_Measurement( ) |
| 2: | x₀, w₀ ← Initialise(model) |
| 3: | if variant ≠ FL-SMC then |
| 4: | l ← 0, only FL-SMC uses particle and data trajectories |
| 5: | end if |
| 6: | for t ← 1; t < T_{SMC}; t ← t + 1 do |
| 7: | if variant ≠ SMC-S or t = 1 then |
| 8: | Yₜ ← New_Measurement( ) |
| 9: | else |
| 10: | Yₜ ← Y₁, measurement is constant in SMC-S |
| 11: | end if |
| 12: | if variant = SMC-S then compute the following for Recycling |
| 13: | wsum ← MPI_Allreduce(wₜ₋₁, ... ), sum of wₜ₋₁ in (13) |
| 14: | end if |
| 15: | x_{t-l:t}, wₜ ← IS(model, x_{t-l:t-1}, wₜ₋₁, Y_{t-l:t}, variant) see (9) and |
| | all variants of (2) |
| 16: | \tilde{w}ₜ ← Normalise(wₜ), see (3) |
| 17: | N_{eff} ESS(\tilde{w}ₜ), see (4) |
| 18: | if N_{eff} N* then perform resampling |
| 19: | ncopies ← MVR(\tilde{w}ₜ), see (6) |
| 20: | x_{t-l:t} ← Redistribute(x_{t-l:t}, ncopies, N) |
| 21: | ${w}_{t} ← Reset ( ) , {w}_{t}^{i} ← \frac{1}{N} ∀ i$ |
| 22: | end if |
| 23: | fₜ ← Estimate(xₜ), see (7) |
| 24: | if variant = SMC-S then improve estimate with recycling |
| 25: | ${c}_{t} ← MPI\_Allreduce ( {w}_{t} , … ) , {c}_{t} ← \frac{{c}_{t}}{w sum} , see ( 13 )$ |
| 26: | if t = 1 then initialise numerator and denominator in (12) |
| 27: | nsum ← fₜcₜ, dsum ← cₜ |
| 28: | else update numerator and denominator in (12) |
| 29: | nsum ← nsum + fₜcₜ, dsum ← dsum + cₜ |
| 30: | end if |
| 31: | fₜ ← Recycling(nsum, dsum), see (12) |
| 32: | end if |
| 33: | end for |

After an initialise step, each iteration produces a new state estimate given one or more measurements. Each iteration requires the following steps (or components): importance sampling (IS), normalise, ESS, resampling and estimate (followed by recycling in the case of SMC samplers). As explained above, particle filters (PF), SMC samplers and fixed-lag SMC are examples of SMC methods. For particle filters, there is one measurement per iteration and resampling is typically only used if needed. For SMC samplers, only one measurement is collected, and the iterations are run given the same measurement. The method finalises estimates with recycling and resampling is used only if needed. For fixed-lag SMC, a history of l>1 measurements is used at each iteration. The method samples and resamples trajectories of l>1 particles. For each of particle filters, SMC samplers and fixed-lag SMC there is a variant when resampling is always used, and this is called Bootstrap Filter.

Each of the components of the SMC module may be parallelised as explained below by one of four parallelisation methods: embarrassing parallel, reduction, cumulative sum and fully-balanced redistribute (such as the new RoSS method). In the process described above, the steps reset, initialise, equations (6), (9) and all variants of (2) are parallelisable using embarrassing parallel because the cores can work simultaneously and independently on each i^{th} element of these operations. They are thus element-wise operations and achieve 0(1) time complexity for P=N cores. The steps represented by equations (3), (4), (7) and (13) require sum and can be easily parallelised by using reduction. The time complexity of any reduction operation scales logarithmically with the number of cores, more precisely as defined below:

0(N/P+log₂P)

On MPI, reduction can be computed by calling MPI_Reduce or MPI_Allreduce. An example of a reduction to compute sum for N=8 elements and P=4 MPI cores is shown in FIG. 2b.

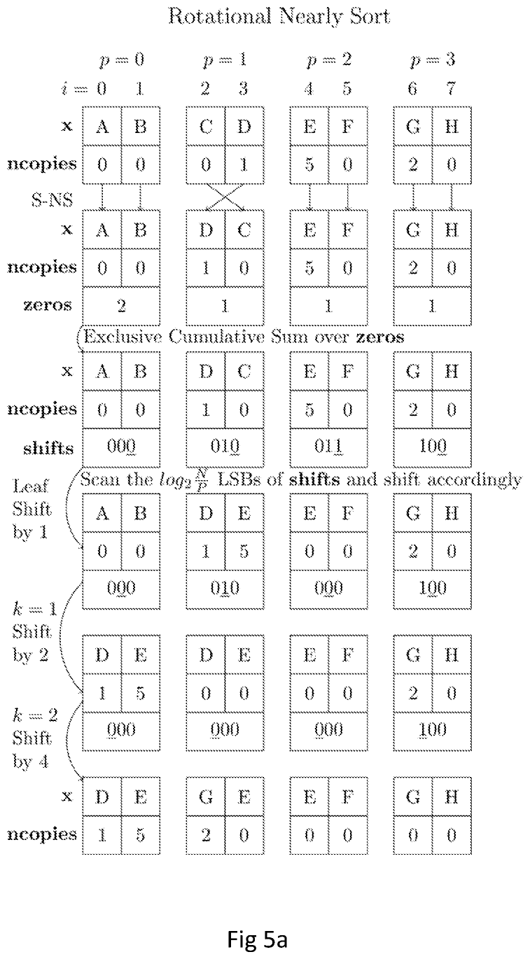

Calculating the cumulative density function (CDF) of the weights requires cumulative sum which is also termed prefix sum or scan in the literature. Parallel cumulative sum scales as above. On MPI, parallel cumulative sum can be computed by calling MPI_Scan or MPI_Exscan as described for example in [34]. An example for N=8 elements and P=4 MPI cores is shown in FIG. 5b.

The redistribute step used in the process above and described below in detail is a new fully-balanced and deterministic redistribute step. By contrast, some known techniques which are used in the redistribute step are impossible to parallelise in an element-wise fashion. For example, a textbook implementation of redistribute is described as sequential redistribute (S-R) and the algorithm is shown in the following pseudo-code:

Algorithm 2 - Sequential Redistribute (S-R)

| Input: x, ncopies, n | |
|---|---|
| Output: x_{new} | |
| 1: | i ← 0, initialise the index of the output array |
| 2: | for j ← 0; j < n; j ← j + 1 do |
| 3: | for k ← 0; k < ncopies^{j}; k ← k + 1 do |
| 4: | x_{new}ⁱ ← x^{j}, the particle is duplicated |
| 5: | i ← i + 1, update the index of the output array |
| 6: | end for |
| 7: | end for |

It is impossible to simply divide equally the iteration space across the cores because each ncopiesⁱ randomly changes at every iteration t as it may be equal to any integer number between 0 and N. Therefore, an element-wise parallelisation would be extremely unbalanced. On DMAs, parallelisation is even more problematic because the cores can only directly access their own private memory.

The fully-balanced redistribute step of the present techniques has a perfectly balanced network where the cores deterministically perform the same computation and send/receive the same number of messages. Since the result is exactly the same as S-R, a resampling step using the fully-balanced redistribute process described below provides an exact result. A fully-balanced redistribute step is one in which the cores deterministically perform the same computation and send/receive the same number of messages. An alternative way of parallelising the redistribute step is a central unit approach. In this approach, the central unit(s) may be overworked in comparison with the remaining cores because they perform extra duties, such as decision making, particle duplication, particle routing to the other cores or a combination of them. Some central unit approaches may sacrifice accuracy to have faster communication between the cores [20], or they might be non-deterministic [14], [15]which potentially translates to little or no scalability when, in the worst case, the workload is centralised to a single core [19].

As shown below, the redistribution in the new method happens in logarithmic time complexity by using a three-phase approach where the first two phases take 0(log₂N) steps. After that, S-R can be performed locally in constant time, as explained below. FIG. 3 illustrates the goal of each phase through a practical example with N=8 particles and P=4 MPI cores. In FIG. 3, the value of each particle xⁱ (where the subscript t is omitted for brevity) is denoted by a capital letter for brevity but it is noted that the value is actually a vector of M real numbers.

Before the redistribute step, the values of each of the eight particles x⁰ to x⁷ are distributed across the cores in order, i.e. the lowest ranked core p=0 has the values of the two lowest numbered particles x⁰ and x¹. The number of copies of each particle (ncopiesⁱ) is determined as described above and is stored with the value of the particle. As shown, zero copies of particles x⁰, x¹, x², x⁵ and x⁷ are required together with 1 copy of particle x³, 5 copies of particle x⁴, and 2 copies of particle x⁶. In the first phase of the redistribute step, all particles which must be duplicated are moved to the left (i.e. moved to cores having lower ranking) using a technique termed rotational nearly sort. This also automatically creates empty spaces, or gaps, on the higher ranked cores, that can be filled with particles to duplicate. In other words, the purpose of this phase is to ensure that the particles which are to be duplicated are separated from those which are not to be duplicated. As shown in FIG. 3, after rotational nearly sort, the particles x³, x⁴ and x⁶ along with their number of copies to create are moved to the two lowest ranked cores.

The next phase of the redistribute step is to fill the empty spaces on the higher ranked cores with the required number of copies. However, instead of directly filling the gaps, the next phase is termed rotational split and creates room to the right (i.e. in the next highest core) of each particle value to duplicate and fills the gaps at the same time.

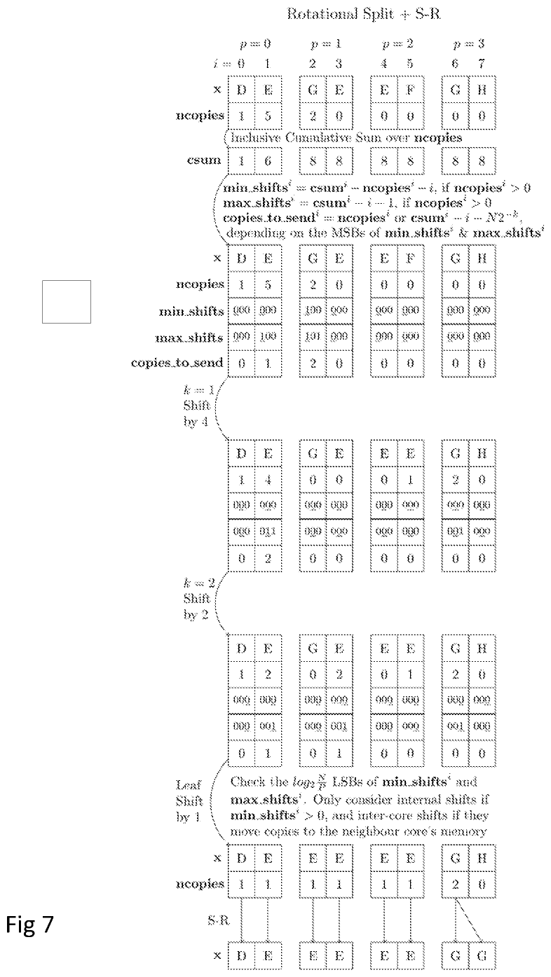

The final phase, illustrated in FIG. 7, is S-R and is performed after the rotational split phase. This final phase is to redistribute the particles within each MPI core. This way, all the remaining gaps from rotational split will be filled. Thus, as shown, the two copies of the value of particle x⁶ are split across the highest ranked core (p=3) which is being used.

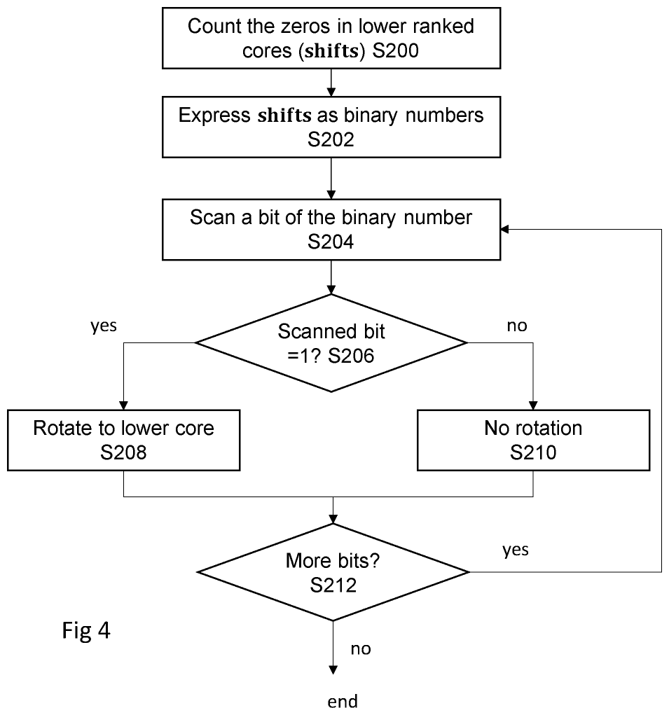

FIG. 4 shows the approach of the rotational nearly sort phase which may be described qualitatively as follows. The strategy for getting every particle that must be duplicated to the left is to first count the zeros that each of these particles can see on their left side (step S200), i.e. determining how many particles in lower ranked cores are not to be duplicated. The number of zeros is the number of positions to shift by onto the left and thus the terms zeros and shifts may be used interchangeably in this context. Referring to FIG. 3, particles x³ and x⁴ see 3 zeros on their left while particle x⁶ sees 4 zeros. In the next step S202, the number of zeros may be expressed as binary numbers, for example 3=(011)₂. The next step is to scan a bit of the binary number (step S204). The scanning starts with the least significant bit (LSB) and moves to the most significant bit (MSB). There is a determination (step S206) as to whether the scanned bit is equal to 1. If the bit is equal to 1, the value of the particle will be rotated to the left (step S208) by a number of positions which is based on the bit which has been scanned. If the bit is equal to 0, there is no rotation (step S210). If there are more bits as determined in step S212, the next bit is scanned and step S204 to S212 are repeated until there are no more bits.

In other words, at every iteration, the bits will be scanned and rotations to the left will be performed if and only if the scanned bit is 1. For the example of particle x³, at the first iteration, the bit is 1 and thus there is rotation to the left by one position because this is the first iteration. In the second iteration, the relevant bit is also equal to 1 and thus again there is rotation but in this case by two positions because this is the second bit (and second iteration). In the third (and final) iteration, the relevant bit is 0 and thus there is no rotation. Since all particles shift to the left and follow an LSB to MSB order strategy, it is impossible that two consecutive particles for which ncopiesⁱ>0 will collide, because during the rotations, they will at most catch up with each other. For example, particles x⁴ and x⁶ are separated by a zero and must rotate by three and four positions respectively. However, by the time x⁶ has to rotate by four, x⁴ will have already rotated by three positions.

The following is an example of an algorithm which may be used to implement the rotational nearly sort process described in FIG. 4:

Algorithm 5 - Rotational Nearly Sort
$Input : x , ncopies , N , P , = \frac{N}{P} , p$
Output: x, ncopies

| | |
|---|---|
| 1: | x, ncopies, zeros ← S-NS(x, ncopies, n), see Algorithm 3 |
| 2: | shifts ← MPI_Exscan(zeros, ... ), compute shifts |
| 3: | if P ← N then perform leaf stage of the binary tree |
| 4: | partner ← (p − 1)&(P − 1), i.e. neighbour |
| 5: | $if ( shifts \& ( n - 1 ) ) > 0 then at least one of the {log}_{2} ( \frac{N}{P} ) LSBs$ |
| | is 1 |
| 6: | for i ← 0; i < n; i ← i + 1 do |
| 7: | if i < shifts & (n − 1) then |
| 8: | Send xⁱ, ncopiesⁱ to partner |
| 9: | ncopiesⁱ ← 0, delete the sent particle |
| 10: | else |
| 11: | Shift particle to the left by shifts & (n − 1) |
| | positions |
| 12: | end if |
| 13: | end for |
| 14: | Send shifts − shifts & (n − 1) (number of shifts left) to |
| | partner |
| 15: | shifts ← shifts − shifts & (n − 1), update shifts |
| 16: | else |
| 17: | Send an array of −1s to partner (Message to reject) |
| 18: | end if |
| 19: | Accept or reject the received particles and shifts |
| 20: | end if |
| 21: | for k ← 1; k ≤ log₂P; k ← k + 1 do binary tree |
| 22: | partner ← (p − 2^{k-1})&(P − 1) |
| 23: | if (shifts & n2^{k-1}) > 0 then the new LSB of shifts is 1 |
| 24: | for i ← 0; i < n; i ← i + 1 do |
| 25: | Send xⁱ, ncopiesⁱ to partner |
| 26: | ncopiesⁱ ← 0, delete the sent particle |
| 27: | end for |
| 28: | Send shifts − shifts & n2^{k-1} (number of shifts left) to |
| | partner |
| 29: | shifts ← shifts − shifts & n2^{k-1}, update shifts |
| 30: | else |
| 31: | Send an array of −1s to partner (Message to reject) |
| 32: | end if |
| 33: | Accept or reject the received particles and shifts |
| 34: | end for |

FIG. 5a illustrates a correct and efficient implementation of the rotational nearly sort phase which is described technically below. As set out in FIG. 4, the first step of the phase is to determine the number of zeros in the lower ranked cores. In the detailed implementation of FIG. 5a, this is implemented in two stages. In a first stage, a nearly sort routine is applied to the particles within the memory of each core, for example by calling a routine such as the sequential nearly sort (S-NS) illustrated in the following pseudo-code:

Algorithm 3 - Sequential Nearly Sort (S-NS)

| Input: x, ncopies, n | |
|---|---|
| Output: x_{new}, ncopies_{new}, zeros | |
| 1: | left ← 0, right ← n − 1, initialise left and right indexes |
| 2: | for i ← 0; i < n; i ← i + 1 do |
| 3: | if ncopiesⁱ > 0 then copy the particle to the left |
| 4: | x_{new}^{left} ← xⁱ, ncopies_{new}^{left} ← ncopiesⁱ |
| 5: | left ← left + 1, update the left index |
| 6: | else copy the particle to the right |
| 7: | x_{new}^{right} ← xⁱ, ncopies_{new}^{right} ← ncopiesⁱ |
| 8: | right ← right − 1, update the right index |
| 9: | end if |
| 10: | end for |
| 11: | zeros ← n − left, compute the number of zeros |

Such a routine only takes 0(N/P) iterations. As shown in FIG. 5a, the particles are moved to the left of the core in which they are located. For example, particle x³ is moved from the right side to the left side of the core p=1.

It is noted that at this point, it is possible to prove that the particles within core p must shift to the left by as many positions as the number of zero elements in ncopies owned by the cores with a lower rank. If zeros is the array which counts the number of ncopiesⁱ=0 within each core, each element of shifts can be initialised as follows:

shifts^{p}=Σ_{\tilde{p}=0}^{p-1}zeros^{\tilde{p}} (14)

zeros∈ [symbol] ^{P}

shifts∈ [symbol] ^{P}

0≤zerosⁱ≤N, ∀i

0≤shiftsⁱ≤N, ∀i

where shifts is the array to keep track of the remaining shifts, zeros is the array which counts the zeros within each core and p is the number of the core.

The next stage shown in FIG. 5a is to parallelise equation (14) using parallel exclusive cumulative sum after each core p has initialised zeros to the sum of zeros within its memory, at the end of the routine S-NS. FIG. 5b illustrates an example of the process for exclusive cumulative sum. The first stage is to calculate:

csum^{j}←csum^{j-1}+array^{j}∀j=1,2, . . .

As we can see, for core p=0 and j=0 within the core, the array has a value of 2 and thus the value for the first location in csum is also 2. All the other values in the array are 0 and thus the value for each entry in csum is 2. In the next step, the final value from csum is duplicated to form {coreSum, sum}. The cores are partnered and sum is exchanged with the partner and the received value is added (as in the reduction operation). For the higher ranked partner, the received value is also added to the value of coreSum. In the final stage:

$${csum}^{0} ← coreSum - {csum}^{\frac{N}{P} - 1} \\ {csum}^{j} ← {csum}^{j - 1} + {array}^{j} ∀ j = 1 , 2 , …$$

Returning to FIG. 5a, we have 2 shifts for core p=1, 3 shifts for core p=2 and 4 shifts for core p=3; the core p=0 will never perform shifts since it is on the left by definition. Once the number of shifts has been calculated, as set out in FIG. 4, the number is expressed in binary notation and the particles and the number of the remaining shifts needed are shifted by increasing power of two numbers of position, depending on the bits of the binary number (shifts^{p}). This translates to a bottom-up binary tree structure which will complete the task in 0 (log₂N) time. For the example, we have 2=(010)₂ shifts for core p=1, 3=(011)₂ shifts for core p=2 and 4=(100)₂ shifts for core p=3.

If P<N, as shown in FIG. 5a, a leaf shift stage may be performed before starting the actual tree-structure routine described below. In this additional leaf shift stage, the MPI cores send all the particles to their neighbour core, when the bitwise & of shifts^{p} and N/P−1 is positive. In simple terms, the leaf stage takes care at once of the rotations referring to the first log₂(N/P) bits of shifts^{p}. For the example in FIG. 5a, the number of cores is 4 and the number of particles is 8 and thus the additional leaf shift stage may be used. In this example, only the value E for which 5 copies are required is moved from the core p=2 to its neighbouring core p=1.

Examples of the bitwise & are shown below. In the first example, N=64, P=8 such that log₂(N/P)=3. In this example, we wish to mask the log₂(N/P) LSBs of a number. If the input number is 43, this is written in binary as (101011)₂. The mask is equal to N/P−1, i.e. 7 which in binary is (000111)₂. The bitwise & result is thus (000011)₂. In the second example, we select the δ^{th} bit of a number for δ=1, 2, . . . , log₂N. In this example, δ=4 and N=64. The input number is 43, this is written in binary as (101011)₂. The mask is equal to 2^{δ-1}, i.e. 8 which in binary is (001000)₂. The bitwise & result is thus (001000)₂. In both examples, the & operation of two bits equals 1 only if both bits are 1, otherwise it equals 0.

After the optional leaf stage, the actual tree-structure routine can start. At every k^{th} stages of the tree (k=1, 2, . . . , log₂P), any core p will send to its partner p−2^{k-1} all its particles (i.e. x and ncopies) and shifts^{P}−N/P2^{k-1} (i.e. the number of remaining shifts after the current rotation), if and only if:

(shifts^{p}&N/P2^{k-1})>0

This corresponds to checking a new bit of shifts^{p}, precisely the one which is significant to this stage. At every stage, the particles will then shift by an increasing power of two number of positions and shifts get updated in 0(1). Thus, as shown in FIG. 5a, when k=1, each particle in core p=1 is shifted by 2 and the particle in core p=3 is not moved. When k=2, the particles which are moved are shifted by 4 and thus as shown the particle in core p=3 is moved. Therefore, since shifts^{p}≤N−1, because a particle must shift at most from one end to the other end, the overall achieved time complexity is equal to 0(log₂N). At the end of the rotational nearly sort phase, as shown in FIG. 3 and FIG. 5a, ncopies has the following shape:

ncopies=[λ⁰, λ¹, . . . , λ^{m-1}, 0, . . . , 0] (15)

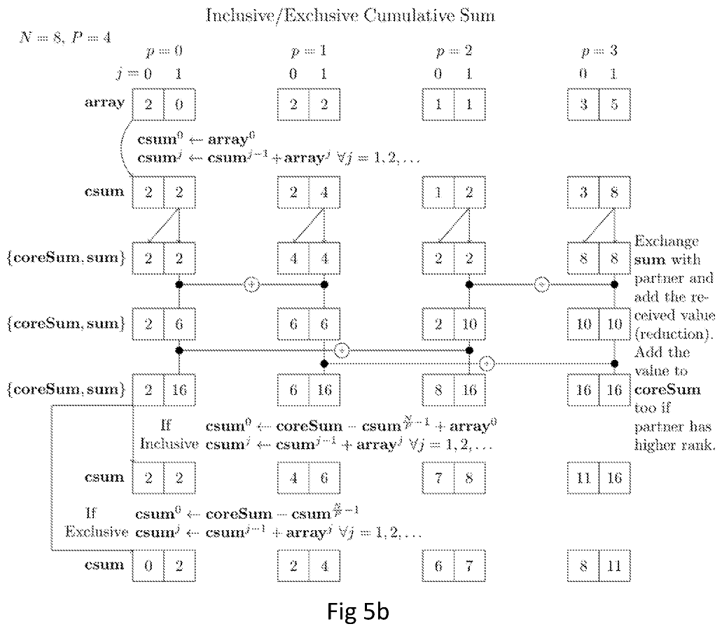

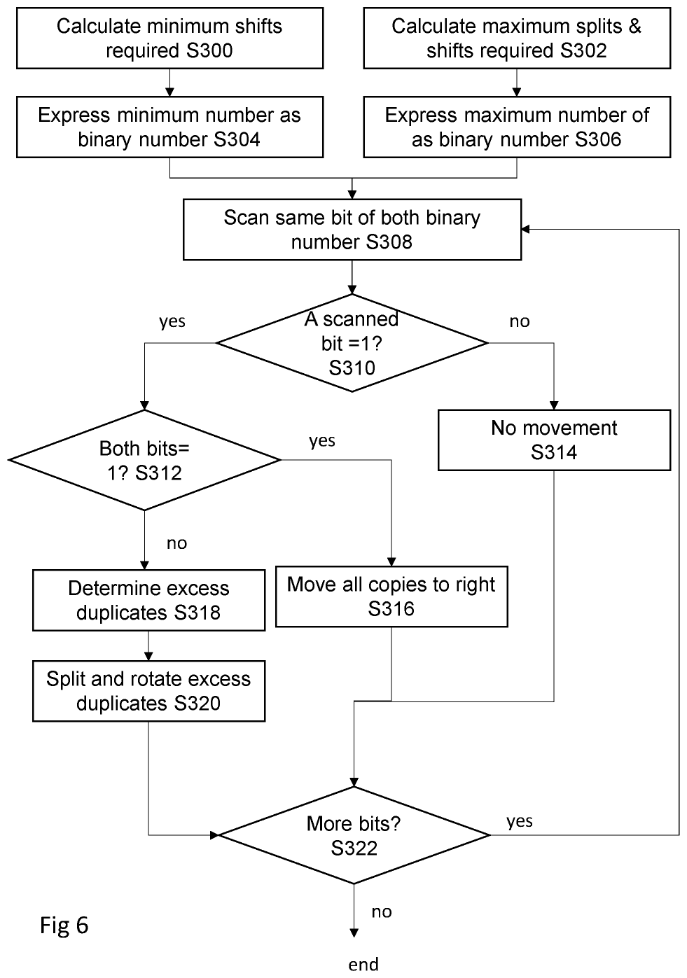

FIG. 6 shows the approach of the rotational split phase which may be described qualitatively as follows. In order to have enough gaps for the particles to be safely duplicated, for each ncopiesⁱ>0, to anticipate the space needed for the duplicates of the associated particle there would need to be ncopiesⁱ−1 zeros to follow on the right (i.e. to be available in the higher ranked cores). It is also necessary to split and place copies of the particle xⁱ onto the zeros that follow in order to progressively balance the workload across the cores. Both these aims may be achieved by computing two quantities namely the minimum shifts for each particle xⁱ to securely distance itself from all the particles to its left, and the maximum splits and shifts for the copies of xⁱ to safely end up in one of the zeros that follow.

The minimum number of shifts may be calculated (step S300) by summing up all the (ncopiesⁱ−1) terms on the left of the i^{th} particle. Thus, for the example in FIG. 3 and the particle in position i=2, the minimum number of shifts is (ncopies⁰−1)+(ncopies¹−1), i.e. (1−1)+(5−1)=4. The maximum number of splits and shifts which are required may be calculated (step S302) by summing the minimum number of splits with the value of (ncopiesⁱ−1). For the example in FIG. 3 and the particle in position i=2, the minimum number of shifts is 4 and (ncopies²−1)=1 such that the maximum number of shifts is then 4+1=5. Similarly, for the particle in position i=1, the minimum number of shifts is (ncopies⁰−1)=0 and maximum number of shifts is (ncopies⁰−1)+(ncopies¹−1)=4 .

The next steps of the method are to express the minimum and maximum as binary numbers (steps S304, S306). Thus, the minimum and maximums for the particle in position i=2 are expressed as (100)₂ and (101)₂, respectively. The minimum and maximums for the particle in position i=1 are expressed as (000)₂ and (100)₂, respectively. The binary numbers are then scanned and rotations are based on the scanned bits as in the rotational nearly sort process, However, in the rotational split process, the binary numbers are scanned in the opposite direction. In other words, progressively smaller power of two rotations to the right are carried out depending on the MSB of the binary notation for the minimum and maximum shifts. This is because the particles are to be scattered rather than gathered together. For each particle, three scenarios may occur: none of the copies must move; all of them must rotate; or only some must split and shift while the remaining ones keep still.

The scanning and moving may be implemented as shown in steps S310 onwards. For example, there is a determination as to whether one or both of the scanned bit in each of the binary numbers is 1 (step S310). The particle does not move if neither scanned bit is 1 (step S314). If at least one scanned bit is 1, there is a determination as to whether both bits are 1 (step S312). If both scanned bits are 1, all copies are moved to the right by the number of positions corresponding to the bit which has been scanned (step S316). For example, for the particle in position i=2, the MSB of both the maximum and minimum shifts expressed in binary notation is 1 and therefore all copies of x² are misplaced and must rotate by the number of positions corresponding to the bit which has been scanned, e.g. 2²=4.

If only one of the scanned bits is 1, some copies must be split and rotated while the others must stay in place. The number of copies to be split is equal to how many duplicates of xⁱ are excess and should stay at least as many positions ahead as the rotations related to the scanned bits. The number of excess duplicates may be obtained (step S318) by subtracting from the sum of all ncopiesⁱ up to xⁱ the new position after this round of rotation (equal to i plus the rotations to perform). For example, for the particle in position i=1, the MSB of the maximum and minimum shifts are different and the number of excess duplicates is ncopies⁰+ncopies¹−(i+4)=1. The excess duplicates are then split and rotated (step S320). In this example, the single excess duplicate is copied and rotated by 4 positions and the other copies are maintained in place.

Regardless of whether all, some or no copies are moved, if there are more bits as determined in step S322, the next bit is scanned and steps S310 to S322 are repeated until there are no more bits. As explained in more detail below, it is necessary to use a final process, after rotational split, in order to redistribute within each MPI core.

The following is an example of an algorithm which may be used to implement the rotational split process described in FIG. 6:

Algorithm 6 - Rotational Split
$Input : x , ncopies , N , P , n = \frac{N}{P} , p$
Output: x, ncopies

| | |
|---|---|
| 1: | csum ← MPI_Cumulative_Sum(ncopies, N, P) |
| 2: | min_shiftsⁱ ← csumⁱ − ncopiesⁱ − i, ∀i = 1,2, ... , n − 1 if ncopies > 0 |
| 3: | max_shiftsⁱ ← csumⁱ − i − 1, ∀i = 1, 2, ... , n − 1 if ncopiesⁱ > 0 |
| 4: | for k ← 1; k ≤ log₂P; k ← k + 1 do binary tree |
| 5: | $partner ← ( p + \frac{P}{{2}^{k}} ) \& ( P - 1 )$ |
| 6: | for i ← 0; i < n; i ← i + 1 do |
| 7: | if (max_shiftsⁱ & N2^{-k}) > 0 then at least one MSB is 1 |
| 8: | if (min_shiftsⁱ & N2^{-k}) > 0 then two MSBs are |
| | 1 |
| 9: | copies_to_sendⁱ ← ncopiesⁱ |
| 10: | ncopiesⁱ ← 0 |
| 11: | else only one MSB is 1. Compute particles in |
| | excess |
| 12: | copies_to_sendⁱ ← csumⁱ − i − N2^{-k} |
| 13: | ncopiesⁱ ← ncopiesⁱ − copies_to_sendⁱ |
| 14: | end if |
| 15: | starter ← csumⁱ − copies_to_sendⁱ, if i is first |
| 16: | Send xᵢ, copies_to_sendⁱ to partner and send |
| | also starter if i is first |
| 17: | else |
| 18: | Send −1 to partner (Message to reject) |
| 19: | end if |
| 20: | end for |
| 21: | Accept or reject the received particles and starter. Reset starter |
| | to 0 if all particles are sent and none is accepted |
| 22: | csum⁰ ← starter + ncopies⁰, re-initialise csum |
| 23: | csumⁱ ← csumⁱ⁻¹ + ncopiesⁱ, ∀i = 1,2, ... , n − 1, update csum |
| 24: | Update min_shifts and max_shifts as in step 2 and 3 |
| 25: | end for |
| 26: | if P < N then perform leaf stage of the binary tree |
| 27: | for i ← n − 1; i ≥ 0; i < i − 1 do |
| 28: | if csumⁱ > n(p + 1) then do inter-core shifts |
| 29: | copies_to_sendⁱ ← min (csumⁱ − n(p + 1), |
| 30: | ncopiesⁱ) |
| 31: | ncopiesⁱ ← ncopiesⁱ − copies_to_sendⁱ |
| 32: | Send xⁱ, copies_to_sendⁱ to partner |
| 33: | else |
| 34: | Send −1 to partner (Message to reject) |
| 35: | end if |
| 36: | if min_shiftsⁱ > 0 then do internal shifts |
| 37: | Shift particle to the right by min_shiftsⁱ positions |
| 38: | end if |
| 39: | end for |
| 40: | Accept or reject the received particles |
| 41: | end if |

FIG. 7 illustrates a correct and efficient implementation of the rotational split and sequential redistribute phases. Rotational split is described technically below. The goal of this phase is to fill the gaps in a way that balances the workload across the MPI cores. Balancing the workload across the MPI cores is equivalent to having:

$${\sum }_{i = p \times \frac{N}{P}}^{( p + 1 ) \times \frac{N}{P}} {ncopies}^{i} = \frac{N}{P} ∀ p = 0 , … , P - 1 \qquad ( 18 )$$

which is essentially equation (5) above applied locally. This can be achieved by making enough room between the particles that have to be copied and creating the copies in these new empty spaces. While these two steps could be performed one after another, in this section, it is shown that it is possible to perform both at the same time in 0(log₂N). For clarity, we believe it is more intuitive to illustrate how to achieve the first step alone and then how to extend that to accomplish the result of equation (18).

As set out above, after the rotational nearly sort phase, ncopies has the shape shown in equation (15). Therefore, making enough room between the particles that have to be copied easily translates to shifting the particles to the right until ncopies has the new shape:

ncopies=[λ⁰, 0, . . . , 0, λ¹, 0, . . . , 0, λ^{m-1}, 0, . . . , 0] (19)

where for each ncopiesⁱ>0, ncopiesⁱ−1 zeros follow.

As shown in FIG. 7, the first step of the rotational split process is to perform an inclusive cumulative sum (csum) over the ncopies. The inclusive cumulative sum is shown in FIG. 5b. The steps are the same as for exclusive cumulative sum except that in the final stage:

$${csum}^{0} ← coreSum - {csum}^{\frac{N}{P} - 1} + {array}^{0} \\ {csum}^{j} ← {csum}^{j - 1} + {array}^{j} ∀ j = 1 , 2 , …$$

The value of csumⁱ can be used to calculate the minimum and maximum number of shifts (steps S300 and S302 of FIG. 6) for the i^{th} particle as well as the number of excess duplicates to send also termed copies_to_send (step S318 of FIG. 6) using:

min_shiftsⁱ=Σⱼ₌₀ⁱ⁻¹(ncopies^{j}−1)=csumⁱ−ncopiesⁱ−i (20)

max_shiftsⁱ=min_shiftsⁱ+ncopiesⁱ−1=csumⁱ−i−1 (21)

copies_to_sendⁱ=csumⁱ−i−N2^{-k} (22)
where csum∈ [symbol] ^{N}

To achieve the new shape for ncopies in equation (19), we consider each min_shiftsⁱ in binary notation and scan the bits from the MSB to the LSB. The particles are rotated to the right by decreasing power of two numbers of bit position, if and only if the MSB of min_shiftsⁱ is 1. This corresponds to using a top-down binary tree structure of height 0(log₂N). At each stage k of the tree (for k=1, 2, . . . , log₂P), any core with rank p sends particles N2^{-k} positions ahead to its partner with rank

$$p + \frac{P}{{2}^{k}} .$$

By repeating these steps recursively, ncopies will have the shape in (19) but not (18). That is because for each xⁱ that must be copied more than once, we are rotating all its copies by the same number of bit positions and we are not considering that some of these copies could be split and rotated further to ensure ncopies had the shape of (18). This can be achieved by filling some of the gaps that a strategy for ensuring ncopies has the shape of (19) alone would create.

Therefore, as shown in FIG. 6, we do not only consider the minimum number of shifts but also consider the maximum number of shifts that any copy of xⁱ has to perform, without causing collisions. Since (19) aims to create ncopiesⁱ−1 gaps for each i such that ncopiesⁱ>0, max_shiftsⁱ is calculated as set out above. Thus, at each k^{th} stage, we check the MSB of both max_shiftsⁱ and min_shiftsⁱ to infer copies_to_sendⁱ and the number of copies of xⁱ which must rotate by N2^{-k} positions. If both of them are equal to 1, trivially we send copies_to_sendⁱ=ncopiesⁱ copies of xⁱ (i.e. all copies are moved as per step S316 of FIG. 6).

However, if only the MSB of max_shiftsⁱ is equal to 1, copies_to_sendⁱ<ncopiesⁱ. In this case, the number of copies to split is equal to how many of them must be placed from position i+N2^{-k} to achieve perfect workload balance. This is equivalent to computing how many copies cause it to be the case that csumⁱ>i+N2^{-k}.Therefore, the number of excess duplicates to send also termed copies_to_send (step S318 of FIG. 6) is calculated using equation (22) above and this number of copies is sent and the remaining ones do not move.

Considering the example in FIG. 7 in more detail, at the first stage k=1, we can see that the value G which requires 2 copies (for which i=2) has values of max_shiftsⁱ=5 and min_shiftsⁱ=4. Thus, the MSB of both max_shiftsⁱ and min_shiftsⁱ is 1 and all copies are moved by 4 places. By contrast, at the first stage k=1, the value E (for which i=1) which requires 5 copies has values of max_shiftsⁱ and min_shiftsⁱ of 4 and 0. Thus, only the MSB of max_shiftsⁱ is equal to 1, copies_to_sendⁱ is calculated as 1 and just one value of E is moved by 4 places. In the second stage, k=2, the value E (for which i=1) which requires 4 copies has values of max_shiftsⁱ and min_shiftsⁱ of 3 and 0. Thus, only the next bit value of max_shiftsⁱ is equal to 1, copies_to_sendⁱ is calculated as 2 and two values of E are moved by 2 places.

In case P<N, after log₂P stages, each core p will perform a leaf stage. Here, the log₂(N/P) LSBs of max_shiftsⁱ and min_shiftsⁱ are checked at once. Inter-core shifts are performed or splits and shifts are performed only if they send copies to the neighbour, i.e. if any csumⁱ>n(p+1) where n(p+1) is the first memory address of the neighbour's private memory. Internal shifts are also considered only if min_shiftsⁱ>0, which will make enough room to receive particles from the neighbour since min_shiftsⁱ=max_shiftsⁱ⁻¹+1 (see equations (20) and (21)). As shown in FIG. 7, a leaf stage is applied after the second stage to move one of the two copies of E to the neighbouring location (from i=3 to i=4).

In order to ensure logarithmic time complexity, one needs to update csumⁱ, max_shiftsⁱ and min_shiftsⁱ in 0(N/P). This can be done if the cores send starter=csum^{j}−copies_to_send^{j}, where j is the index of the first particle to send, having ncopies^{j}>0. Because the particles are rotated by scanning the bits of in max_shiftsⁱ and min_shiftsⁱ and by using an MSB-to-LSB strategy, it is impossible for a particle to overwrite or get past another one. Hence each core can safely see the received starter as the sum of ncopies for the cores with lower rank and use it to re-initialise and update csumⁱ in 0(N/P) as set out below. This strategy guarantees that csumⁱ is always correct only for any index i such that ncopiesⁱ>0, but those are the only indexes we are interested in. Once csumⁱ is computed, equations (20) and (21) are trivially parallelisable. The pseudocode for rotational split is found in Algorithm 6. The update for csumⁱ is:

csumⁱ=csumⁱ⁻¹+ncopiesⁱ

It is easy to infer that both min_shiftsⁱ<N−1 and max_shiftsⁱ≤N−1 because a particle copy could at most be shifted, or split and shifted from the first to last position. Therefore, because the shifts or the splits and shifts to perform decrease stage by stage by up to a factor of two, the achieved time complexity of rotational split is 0(log₂N). Additionally, no collision can occur because each particle copy is shifted by at least min_shiftsⁱ and by at most max_shiftsⁱ.

The final phase, which is illustrated in FIG. 7, is the sequential redistribute (S-R) process, whose pseudo code is illustrated in Algorithm 2. This process is called to fill the remaining gaps in each core. After rotational split, S-R can be invoked locally and will finish in 0(N/P) iterations because the particles are now equally distributed across the MPI ranks.

Thus, in summary the overall redistribute step (step S114of FIG. 2a) comprises a rotational nearly sort phase and a rotational split phase only if P>1 before calling S-R. Thus, the achieved time complexity may be inferred as 0(N) for P=1, 0(log₂N) for P=N cores and for any 1≤P≤N is:

$$O ( \frac{N}{P} + \frac{N}{P} {log}_{2} P ) \qquad ( 23 )$$

The first term in (23) represents S-R which is always performed and all the steps which are called only once for any P>1, such as S-NS. The second term describes the log₂P stages of the rotational nearly sort and rotational split phases during which we update, send and receive up to N/P particles. The overall algorithm may be termed rotational nearly sort and split (RoSS) redistribute and the pseudo code may be written as:

Algorithm 7 - Rotational Nearly Sort and Split (RoSS)
$Input : x , ncopies , N , P , n = \frac{N}{P} , p$
Output: x

| | |
|---|---|
| 1: | if P > 1 then perform load balancing |
| 2: | x, ncopies ← Rotational_Nearly_Sort(x, ncopies, N, P, n, p), see |
| | Algorithm 5. ncopies has now shape (15) |
| 3: | x, ncopies ← Rotational_Split(x, ncopies, N, P, n, p), see |
| | Algorithm 6. ncopies has now shape (19) and is |
| | fully-balanced |
| 4: | end if |
| 5: | x ← S-R(x, ncopies, n), see Algorithm 2. Each core duplicates particles |
| | independently within its memory |

Thus, all tasks in the SMC take either 0(1) or 0(log₂N) time complexity, which brings down the overall time complexity to be equal to 0 (log₂N). Even if it was possible to perform a fully-balanced redistribute in 0(1), the time complexity of SMC will still be 0(log₂N) due to normalise, ESS, MVR, estimate and recycling which all require reduction or cumulative sum as set out in the table below.

The RoSS redistribute process described above could be improved in different ways. For example, a hybrid shared DMA may be used rather than a normal DMA by simply substituting the sequential bits in RoSS with their shared memory equivalent, by using, e.g. GPUs or mainstream CPUs. For example, S-R could be substituted with its OpenMP version described in [12] (which on SMAs only achieves 0(log₂N) as well). Since hybrid shared DMAs have fewer MPI nodes than pure DMAs, the number of messages will be trivially lower.

Another idea that can save messages is to check the maximum MSB for all shiftsⁱ and all max_shiftsⁱ at the beginning of rotational nearly sort and rotational split respectively. This will allow us to finish the execution of either of the two steps early and avoid sending unnecessary messages. For example, if ncopies happens to be nearly-sorted already, all bits in shifts will be 0, meaning that no messages should be sent and rotational nearly sort could be skipped entirely. However, this practice is only potentially faster as it is highly non-deterministic; therefore, we strongly do not recommend it for real-time applications.

We also denote that an m-ary tree structure with m>2 cores per each node would theoretically save MPI messages versus a binary tree structure because the tree height would decrease from 0(log₂N) to 0(logₘN). However, the operations to compute per each node would also increase and would be much more complicated to code, meaning that the overall run-time could be equal or worse. This is why when it comes to arrays, binary trees are widely considered more efficient. The table below illustrates the time complexity of each task of SMC on DMAs using RoSS:

| Task name | Sequential | Parallel |
|---|---|---|
| (parallelization strategy) | time complexity | time complexity |
| Initialise | 0(N) | 0(1) |
| (Embarrassing parallel) | | |
| Importance sampling | 0(N) | 0(1) |
| (Embarrassing parallel) | | |
| Normalise (Reduction) | 0(N) | 0(log₂N) |
| ESS (Reduction) | 0(N) | 0(log₂N) |
| MVR (Cumulative sum) | 0(N) | 0(log₂N) |
| Redistribute (RoSS) | 0(N) | 0(log₂N) |
| Reset (Embarrassing parallel) | 0(N) | 0(1) |
| Estimate (Reduction) | 0(N) | 0(log₂N) |
| Recycling (Reduction) | 0(N) | 0(log₂N) |

We also note that this document describes a redistribute algorithm for particles having fixed size M. In some applications, the particle size can change at run-time, specifically across different particles and/or SMC iterations. To handle this case, one only needs first to identify the size of the biggest particle (which can be computed in 0(log₂N) by using reduction) and then extend the other particles by adding extra dimensions with uninformative values, such as NaNs (i.e. not a numbers). After that, the particles have all the same size and can be redistributed by using any redistribute algorithm, such as prior art variants or the novel invention described here.

There exist other Monte Carlo methods that require resampling (and hence redistribute). Notable examples are Bootstrap methods and Jackknife methods, where IS, normalise, ESS and recycling are not used, and resampling and estimate are always performed to respectively correct the degeneracy of the initial distribution and produce new state estimates.

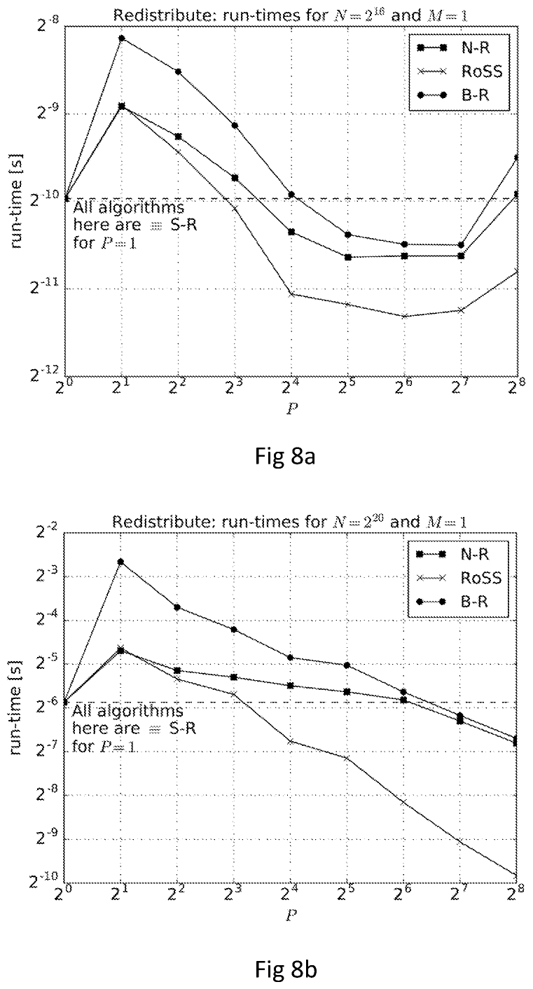

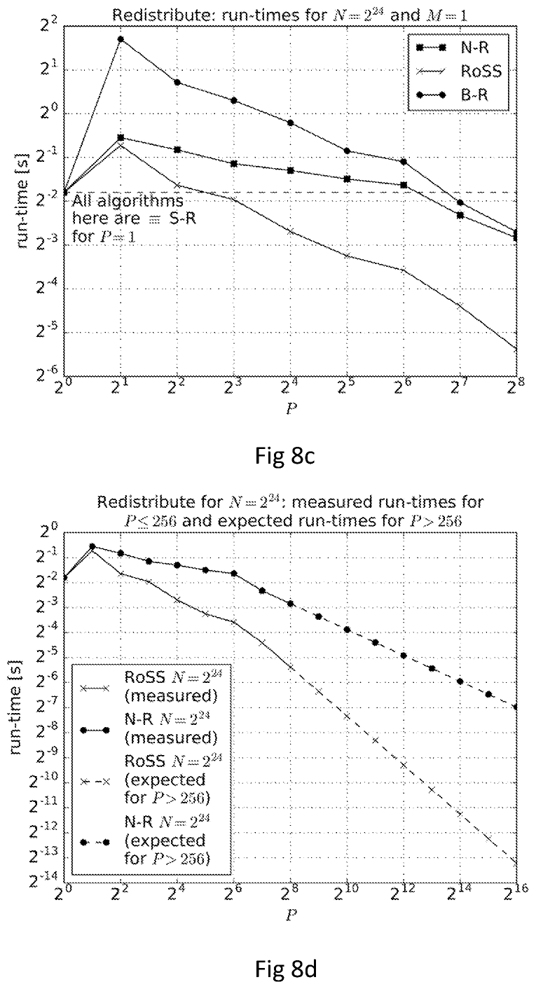

The following Figures show the numerical results of redistribute first (FIGS. 8a to 8d) and then for an exemplary SMC module. All experiments in this section are conducted for N=2¹⁶, 2²⁰, 2²⁴ particles and for up to P=256 cores. Every reported speed-up or run-time represents the median value of 20 runs collected for the same N, P pair and computed in comparison with the baseline, i.e. the results for P=1. Each SMC test is run for T_{SMC}=100 SMC iterations. Resampling is computed every time to ensure the frequency of redistribution is the same. All software to run the described algorithms have been written in C++and run on the same cluster whose technical specifications are provided in the table below:

| Name | Barkla |
|---|---|
| OS | CentOS Linux 7 |
| Number of nodes | 8 |
| Cores per node | 40 |
| CPU | 2 Xeon Gold 6138 |
| RAM | 384 GB |
| MPI version | OpenMPI-1.10.1 |
| Interconnect | Infiniband 100 Gbps |
| Job scheduler | Slurm |

FIGS. 8a to 8d compare single iterations of RoSS redistribute with two other known algorithms which may be termed N-R and B-R. N-R is the nearly sort based redistribute algorithm described in [23]. B-R is an algorithm which we refer to as Bitonic sort based redistribute and is described in [22]. The pseudo code for both N-R and B-R is summarised in algorithm 4 below. A single algorithmic summary is used because they only differ in the sorting strategy they apply on ncopies and they therefore both achieve 0((log₂N)²) time complexity. When implementing a particle filter, each of RoSS, N-R and B-R are used in the redistribute step. The other phases of the whole algorithm are unaltered and to make sure that equation (5) is guaranteed when we quantify performance, ncopies is generated using MVR with a random Gaussian vector of normalised importance weights in input. This ensures that the statistics of the weights are similar to those encountered when considering the particle filter examples and that the performance gains that we quantify the benefit of the novel component can be expected to be similar to those encountered when that component is used in a particle filter.

Algorithm 4 - Bitonic/Nearly sort based Redistribute (B-R/N-R)
$Input : x , ncopies , N , P , n = \frac{N}{P} , p$
Output: x

| | |
|---|---|
| 1: | if P > 1 then Bitonic or nearly sort the particles |
| 2: | if Bitonic sort is used as in [19] then |
| 3: | MPI_Bitonic_Sort(x, ncopies, n) |
| 4: | else nearly sort is used as in [23] |
| 5: | MPI_Nearly_Sort(x, ncopies, n) |
| 6: | end if |
| 7: | end if, ncopies has now shape (15) |
| 8: | for k ← 1; k ≤ log₂P; k ← k + 1 do distribute |
| 9: | $csum ← MPI\_Cumulative \_Sum ( ncopies , \frac{N}{{2}^{k}} , \frac{P}{{2}^{k}} ) , the \frac{P}{{2}^{k}} cores of$ |
| | each tree node of stage k perform cumulative sum over |
| | ncopies |
| 10: | pivot ← Linear_Search (ncopies, csum, n), pivot is 0 if not found |
| 11: | pivot ← MPI_Allreduce(pivot, ... ), broadcast pivot to all cores of |
| | the same tree node |
| 12: | $r ← pivot - ( \frac{N}{2} - 1 )$ |
| 13: | $x , ncopies ← MPI\_Rotational \_Shifts ( x , ncopies , r , n , p , \frac{P}{{2}^{k}} ) ,$ |
| | $the \frac{P}{{2}^{k}} cores of each tree node of stage k express r$ |
| | $in base - 2 and rotate the \frac{N}{{2}^{k + 1}} particles by r positions$ |
| | according to its bit |
| 14: | end for |
| 15: | x ← S-R(x, ncopies, n), see Algorithm 2. Each core duplicates particles |
| | independently within its memory |

The table below summarises the time complexity of each task of SMC on DMAs in the single core and parallel case for B-R or N-R:

| Task name | Sequential | Parallel |
|---|---|---|
| (parallelization strategy) | time complexity | time complexity |
| Initialise | 0(N) | 0(1) |
| (Embarrassing parallel) | | |
| Importance sampling | 0(N) | 0(1) |
| (Embarrassing parallel) | | |
| Normalise (Reduction) | 0(N) | 0(log₂N) |
| ESS (Reduction) | 0(N) | 0(log₂N) |
| MVR (Cumulative sum) | 0(N) | 0(log₂N) |
| Redistribute (B-R/N-R) | 0(N) | 0((log₂N)²) |
| Reset (Embarrassing parallel) | 0(N) | 0(1) |
| Estimate (Reduction) | 0(N) | 0(log₂N) |
| Recycling (Reduction) | 0(N) | 0(log₂N) |

Bitonic sort which is used in B-R is a fast deterministic comparison based parallel sorting algorithm which has recently been implemented on a cluster of graphic cards [35]. In [21], it has been shown that, by using a top-down divide-and-conquer approach, redistribute can be parallelised in fully-balanced fashion. Starting from the root node, the key idea consists of sorting ncopies and moving the particles at every stage of a binary tree. This can be achieved by searching for a particular index called pivot which perfectly divides the node into two balanced leaves. In order to find pivot, parallel inclusive cumulative sum is performed over ncopies and then pivot is the first index where cumulative sum is equal to or greater than

$$\frac{N}{2} .$$

once pivot is identified, the node is split. Sorting the particles, using Bitonic sort, is required to make sure that the splitting phase can be performed deterministically in 0(1). This routine is repeated recursively log₂P times. For any number of cores P≤N it is demonstrated that Bitonic sort performs the number of comparisons defined by the equation below

$$O ( \frac{N}{P} {( {log}_{2} ( \frac{N}{P} ) )}^{2} + \frac{N}{P} {( {log}_{2} P )}^{2} ) \qquad ( 16 )$$

The first term in equation (16) describes the number of steps to perform Bitonic sort locally and the second term represents the data movement to merge the keys between the cores. Since (16) converges to 0((log₂N)²) for P=N cores and Bitonic sort is performed log₂P times, we can infer that this redistribute in [21] achieves 0((log₂N)³) time complexity. In [20], the idea of using sort recursively is also applied to a dynamic scheduler for RPA and RNA on MPI.

As described in [22], B-R improves the algorithm in [21] by making a subtle consideration: the workload can still be divided deterministically if we perform Bitonic sort only once. After this single sort, the algorithm moves on to another top-down routine where we use rotational shifts to move all particles on the left side of pivot up to the left side of the node. This way the father node gets split into two balanced leaves. This algorithm is recursively performed log₂P times until the workload is equally distributed across the cores; then S-R is called. Rotational shifts are faster than Bitonic sort because the achieved time complexity is equal to 0(log₂N) and, since Bitonic sort is performed only once, the overall time complexity is improved to 0((log₂N)²) for P=N or equal to (16) for any P≤N. In [22], B-R has been implemented on MapReduce and although it was significantly better than the algorithm in [21], its run-time for 512 cores was at best 20 times worse than S-R. In [19], B-R has been ported to DMAs by using MPI. The results have shown substantial speed-up for up to 128 cores, proving that MPI is a more suitable framework than MapReduce to perform B-R.

B-R can be further improved as described in [23] to give the proposed algorithm nearly sort based redistribute (N-R). This improvement substitutes Bitonic sort with an alternative algorithm called nearly sort. It has been proven that one does not actually need to perfectly sort the particles to divide the workload deterministically, but only needs to guarantee ncopies has shape of (15), which is described again below:

ncopies=[λ⁰, λ¹, . . . , λ^{m-1}, 0, . . . , 0]

In order to achieve this property, the particles are first nearly sorted within each core by calling sequential nearly sort (S-NS) in Algorithm 3. Then they are recursively merged as in Bitonic sort by using the same sorting network as used for Bitonic sort. Since S-NS can be performed in linear time and the number of sent/received messages is equal to (log₂P)², we can infer that nearly sort costs the number of iterations defined below:

$$O ( \frac{N}{P} + \frac{N}{P} {( {log}_{2} P )}^{2} ) \qquad ( 17 )$$

FIGS. 8a to 8d show that the gap between the proposed approach and the two other algorithms tends to significantly increase with P. RoSS is comparable with N-R and roughly two to three times faster than B-R for P=2 cores but is up to eight times faster for P=256 than both N-R and B-R.

The cluster, Barkla, which is used is also very small in comparison with large existing systems such as Summit which can provide up to 2.4 million cores. Therefore, the gap between RoSS and N-R/B-R is likely to increase to much larger than eight and this will be realised in settings involving more than P=256 cores. FIG. 8d shows the expected run-times for N=2²⁴ and for P>256, computed by linear interpolation of the measured run-times for P≤256. RoSS is expected to be roughly 75 times faster than N-R for P=2¹⁶ cores.

Particles filters are used to solve filtering problems of a dynamic model. FIGS. 9a onwards illustrate the impact of the RoSS redistribute phase when compared to using N-R or B-R on an exemplary model for which N>2¹⁶ particles were proven necessary to meet accuracy constraints and up to N=2²⁴ were used. The chosen model is a vacuum arc remelting (VAR) which is a secondary melting process used in the final stage of alloy production. In this stage, a continuous arc strikes between an electrode and a solidifying ingot, making the metal melt off the electrode and then fall onto a melt pool to solidify. Since this process is done in a vacuum, a lot of impurities are removed, resulting in higher quality of the finished product. During the VAR process, it is fundamental to keep track of the liquid pool depth which, however, cannot be measured directly. A parallel particle filter can then be used for this case. The following dynamic model is for alloy 718 and is thoroughly explained and used in [9], [10]. Here for brevity, we only highlight the most important details.

Xₜ is nine-dimensional and contains information about the electrode thermal boundary layer Δ, the electrode gap G, the ram position Xᵣₐₘ, the electrode Mₑ, the melting efficiency μ, the centreline pool depth S_{c}, the mid-radius pool depth Sₘ, the Helium pressure pₕₑ, and the current I.

$${Δ}_{t} = {Δ}_{t - 1} + [ \frac{{α}_{r} {C}_{ΔΔ}}{{Δ}_{t - 1}} - \frac{{C}_{Δ p}}{{A}_{e} {h}_{m}} {μ}_{t - 1} ( {V}_{c} + {R}_{i} {I}_{t - 1} ) {I}_{t - 1} ] dt + {G}_{11} dI \qquad ( 24 a )$$

$${G}_{t} = {G}_{t - 1} + [ - \frac{{α}_{0} {α}_{r} {C}_{s Δ}}{{Δ}_{t - 1}} + \frac{{α}_{0} {C}_{Δ p}}{{A}_{e} {h}_{m}} {μ}_{t - 1} ( {V}_{c} + {R}_{i} {I}_{t - 1} ) {I}_{t - 1} - {V}_{ram} ] dt + {G}_{21} dI - {dV}_{ram} \qquad ( 24 b )$$

$${M}_{{e}_{t}} = {M}_{{e}_{t - 1}} + [ \frac{ρ {A}_{e} {C}_{s Δ}}{{Δ}_{t - 1}} - \frac{ρ {C}_{sp}}{{h}_{m}} {μ}_{t - 1} ( {V}_{c} + {R}_{i} {I}_{t - 1} ) {I}_{t - 1} ] dt + {G}_{41} dI \qquad ( 24 c )$$

$${X}_{{ram}_{t}} = {X}_{{ram}_{t - 1}} + {V}_{ram} dt + {dV}_{ram} \qquad ( 24 d )$$

$${μ}_{t} = {μ}_{t - 1} + d μ \qquad ( 24 e )$$

$${S}_{{C}_{t}} = {S}_{{C}_{t - 1}} - [ {A}_{c} ( {S}_{{C}_{t - 1}} - {S}_{{C}_{0}} ) - {B}_{Δ C} ( {Δ}_{t - 1} - {Δ}_{0} ) - {B}_{iC} ( {I}_{t - 1} - {I}_{0} ) - {B}_{μ C} ( {μ}_{t - 1} - {μ}_{0} ) - {B}_{heC} ( {p}_{{he}_{t - 1}} - {p}_{{he}_{0}} ) ] dt - {B}_{iC} dI \qquad ( 24 f )$$

$${S}_{{M}_{t}} = {S}_{{M}_{t - 1}} - [ {A}_{M} ( {S}_{{M}_{t - 1}} - {S}_{{M}_{0}} ) - {B}_{Δ M} ( {Δ}_{t - 1} - {Δ}_{0} ) - {B}_{iM} ( {I}_{t - 1} - {I}_{0} ) - {B}_{μ M} ( {μ}_{t - 1} - {μ}_{0} ) - {B}_{heM} ( {p}_{{he}_{t - 1}} - {p}_{{he}_{0}} ) ] dt - {B}_{iM} dI \qquad ( 24 g )$$

$${p}_{{he}_{t}} = {p}_{{he}_{t - 1}} + dhe \qquad ( 24 h )$$

$${I}_{t} = {I}_{c} + ( {I}_{c} - {I}_{t - 1} ) {e}^{- dt / d τ} + dI \qquad ( 24 i )$$

Where the time interval dt, the melting current I_{c} and the ram speed Vᵣₐₘ are controlled by the user. Here we use dt=5 S, I_{c}=6000 A and Vᵣₐₘ is inferred by setting to 0 the expression between squared brackets in (24b). The process noise terms dI, dVᵣₐₘ, dμ, dhe are Gaussian with 0 mean and covariances (σ_{I}dt)², (σ_{V}_{ᵣₐₘ}dt)², (σ_{μ}μ₀)²dt and (σₕₑpₕₑ_{₀}) 2 dt respectively. Every quantity but Δₜ and Xₜ, and the voltage across Rᵢ (which is related to Iₜ) can be measured directly. Therefore, the set of measurements Yₜ is:

Yₜ=[Gₜ, Xᵣₐₘ_{ₜ}, Mₑ_{ₜ}, S_{C}_{ₜ}, S_{M}_{ₜ}, pₕₑ_{ₜ}, Iₜ, V_{c}+RᵢIₜ]+ [symbol] (0, R) (25)

where

R=diag(σ_{G}², σ_{X}², σ_{M}_{ₑ}², σ_{C}², σ_{M}², σₕₑ_{ₘ}², σ_{I}_{ₘ}², σ_{V}_{ₘ}²)

The particles are initialized as follows:

X₀= [symbol] ([Δ₀, Xᵣₐₘ_{₀}, μ₀, Mₑ_{₀}, S_{C}_{₀}, S_{M}_{₀}, pₕₑ_{₀}, I₀], Q) (26)

where

Q=diag(σ_{Δ}², σ_{G}², σ_{X}², σ_{LC}², σ_{μ}²dt, σₕₑ²dt, σ_{C}², σ_{M}², σ_{I}_{ₘ}²)

Tables IV, V and VI below provide all the constants and a terms in (24), (25), and (26). The dynamics is chosen as proposal such that (2) becomes:

wₜⁱ=wₜ₋₁ⁱp(Yₜ|xₜⁱ)

TABLE IV
Standard deviations for noise terms

| Symbol | Value | Symbol | Value |
|---|---|---|---|
| σ_{Δ} | 5 cm | σ_{I}_{ₘ} | 15 A |
| σ_{I} | 20 A | σ_{LC} | 0.2 kg |
| σ_{V}_{ᵣₐₘ} | 5e⁻⁴ cm/s | σ_{V}_{ₘ} | 0.1 V |
| σ_{μ} | 0.001μ₀ | σ_{C} | 1 cm |
| σₕₑ | 0.001pₕₑ_{₀} | σ_{M} | 1 cm |
| σ_{G} | 0.2 cm | σₕₑ_{ₘ} | 0.01 Torr |
| σ_{X} | 0.005 cm | | |

TABLE V
Parameters for alloy 718

| Symbol | Value | Symbol | Value |
|---|---|---|---|
| C_{ΔΔ} | 40 | B_{iM} | 3.2E−6 cm/s A |
| C_{Δp} | 3.8 | B_{μc} | 6.9E−6 cm/s |
| C_{sΔ} | 6.7 | B_{μM} | 2.7E−4 cm/s |
| Cₛₚ | 1.3 | B_{hec} | −8.1E−4 cm/s Torr |
| A_{c} | 1.9E−3 1/s | B_{heM} | −6.5E−4 cm/s Torr |
| A_{M} | 1.4E−3 1/s | G₁₁ | −5.6E−6 cm/A |
| B_{ΔC} | 2.6E−5 1/s | G₂₁ | 5.4E−7 cm/A |
| B_{ΔM} | −1.3E−4 1/s | G₄₁ | −2.2E−2 g/A |
| B_{ic} | 6.6E−6 cm/s A | dτ | 1 s |

TABLE VI
Nominal Values, furnace and Alloy 718 properties

| Name (Symbol) | Value |
|---|---|
| Nominal electrode thermal boundary layer (Δ₀) | 80 cm |
| Nominal current (I₀) | 6000 A |
| Nominal ram position (Xᵣₐₘ_{₀}) | 0.7 cm |
| Nominal electrode mass (Mₑ_{₀}) | 4800 kg |
| Nominal electrode gap (G₀) | 0.9 cm |
| Nominal Helium pressure (_{Phe}_{₀}) | 3.0 Torr |
| Nominal melting efficiency (μ₀) | 0.44 |
| Nominal centreline pool depth (S_{c}_{₀}) | 15.7 cm |
| Nominal mid-radius pool depth (S_{M}_{₀}) | 13.2 cm |
| Electrode cross section (Aₑ) | 1460 cm² |
| Area fill ratio (α₀) | 0.28 |
| Density (p) | 8.192 g/cm³ |
| Cathode voltage fall (V_{c}) | 21.2 V |
| Electric Resistance (Rᵢ) | 4.37E−4Ω |
| Thermal diffusivity at 300 K (αᵣ) | 2.4E−2 cm²/s |
| Volume specific enthalpy at 1623 K (hₘ) | 5.3E3 J/cm³ |

FIGS. 9a to 9d shows that the speed-up of all particle filters increases as P increases, as we expected from theory. Furthermore, FIGS. 9a to 9c show that a particle filter with RoSS outperforms a particle filter with N-R or B-R by up to a factor of three, which is once again increasing with P. The maximum recorded speed-up is 160 for a particle filter with RoSS and about 50 for a particle filter with N-R or B-R. FIG. 9d shows the run-time for RoSS and N-R in which the results are measured for a number of cores below 256 and extrapolated for a higher number of cores, i.e. above 256. As shown, a particle filter using RoSS could be up to 35 times faster than one using N-R for N=2²⁴ particles and up to P=2¹⁶ cores.

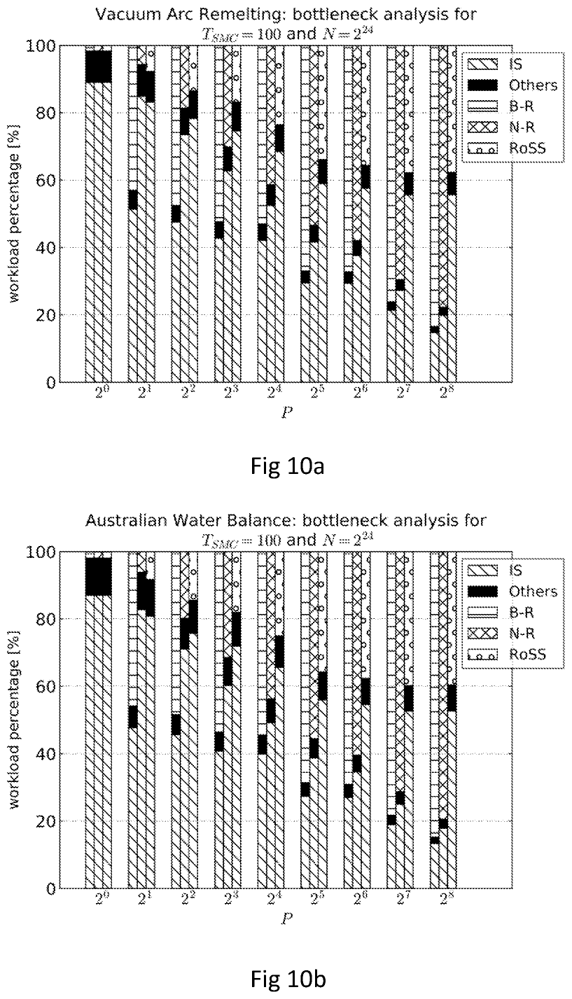

FIG. 10a shows the bottleneck analysis for N=2²⁴ and increasing P for the particle filter using the new redistribute method and the prior art methods. IS takes up a large percentage of the total run-time for low P. We can indeed observe that IS is the bottleneck over any redistribute for P=2. However, as P increases, both N-R and B-R eventually emerge as the bottleneck for 8≤P≤32. On the other hand, it is interesting to see that RoSS still is faster than IS for any P≤256.

Hydrological models are commonly used in the context of urban planning, policy making and water management. The goal is typically to estimate the daily or hourly water runoff levels in a specific and relatively small geographic area, given on-site measurements of rainfall, evapotranspiration, and water flow. Historically, the significant runoff parameters could be tuned by the modellers based on their experience. This approach is however highly prone to human mistakes. Today, SMC methods can be used in substitution. More precisely, SMC samplers can be employed to provide daily or hourly estimates of the runoff parameters because the application is not real-time.

FIGS. 10b and 11a to 11d provide results for an application of the well-known rainfall-runoff Australian Water Balance (AWB) model. Here, for brevity, we highlight the most relevant features, but extra details about all inputs and functions can be found in [36] and [37]. In the generic version of this model, the physical system has a baseflow storage (BS) and a chain of v surface storage areas C_{d}, having increasing capacity C₁<C₂<. . . <C_{d}<. . . <Cᵥ. The surface storages have frictional areas A₁, A₂, . . . , Aᵥ, respectively. As time goes on, part of the rainfall in excess at the surface will refill the BS. More precisely, the baseflow recharge is equal to BFI×Excess and the surface runoff is equal to (1−BFI)×Excess, where BFI is the baseflow index, which determines the percentage of excess rainfall that recharges the BS.

Part of the baseflow recharge gets run off too, according to another index K, called daily recession constant. The state has the following shape:

Xₜ=[K, BFI, C₁, . . . , Cᵥ, A₁, . . . , Aᵥ] (27)

and, therefore, has M=2v+2 dimensions. Here, measurements of water flow at catchments Yₜ are provided daily or hourly and related to the state Xₜ by a non-linear objective function g( )as follows:

Yₜ=g(Xₜ, ϕₜ)+εₜ (28)

where ϕₜ are rainfall and evapotranspiration input data, and εₜ is a homoscedastic Gaussian measurement error with 0 mean. In this experiment, the specific application of the model is for the Bass River, a 52 km² catchment located at Loch in the South Gippsland Basin in Victoria, on the western slope of the Strzelecki Ranges. Here v=3 such that we estimate M=8 parameters.

Every new run of the SMC sampler is initialised as follows:

K˜0.271×Beta(51.9, 4.17)+(1−0.271)×Beta(255, 9.6)

A₁˜Beta(1.4, 2.6)

A₂, A₃˜Beta(2.0, 2.5)

C_{d}˜Weibull(2.16, 136c_{d})

where c_{d}={0.5, 0.75, 1.5}. In the experiment, we focus on single calls of SMC samplers, under the same testing conditions of the VAR model. At every SMC iteration, the same measurement Yₜ=Y₁ is resent to the server, the particles are sampled from a Gaussian distribution, and weighted using (28) as target and backward kernel L( )=q( ).

As can be observed in FIGS. 10b, 11a to 11d, we have very similar results to the previous example: an SMC sampler with RoSS is again up to three times faster than the same using N-R/B-R and RoSS still is the only redistribute option that has not yet emerged as bottleneck. This is not surprising because of two factors: first, this example has almost the same dimensionality as the VAR model in the previous example, and second particle filters and SMC samplers are nearly identical and mostly differ for the particle weighting strategy only.

These results underline well the importance of having a fast, scalable redistribution. Since modern models may be very detailed and complex (e.g. requiring some sophisticated numerical integrator), the IS step also becomes highly computationally intensive. Therefore, a fast redistribute allows SMC methods to maintain a near-linear speed up for higher P, which is what we expect in theory but is hardly achievable in practice.

The findings are encouraging because on the one hand applications of SMC are getting increasingly demanding in terms of accuracy and run-times and on the other hand, modern computers and supercomputers are progressively being built with higher numbers of cores. Therefore, as time goes on, it is getting more important to have a fast parallelisable redistribute, such that in real-world problems, the SMC module can maintain a near linear speed-up for a higher level of parallelism.

The novel fully-balanced redistribute algorithm described above applies to SMC methods running on distributed memory environments. The algorithm has been implemented on MPI. The baselines for comparison are B-R and N-R, two similar state of the art fully-balanced redistribute algorithms which both achieve 0((log₂N)²) time complexity and whose implementation is already available on MPI. However, we have shown that RoSS achieves exactly 0(log₂N) time complexity. The results show that RoSS is up to eight times faster than B-R and N-R for up to P=256 cores. Similar results are observed on two real-world problems. For the same level of parallelism, an SMC method using RoSS is up to three times faster than the same using B-R/N-R and provides a maximum speed-up of 160. Under the same condition, RoSS is no longer the bottleneck.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more cores or processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

The list of references includes:
[1] F. Gustafsson, “Particle filter theory and practice with positioning applications,” IEEE Aerospace and Electronic Systems Magazine, vol. 25, pp. 53-82, July 2010.
[2] R. Delgado-Gonzalo, N. Chenouard, and M. Unser, “A new hybrid Bayesian-variational particle filter with application to mitotic cell tracking,” in 2011 IEEE International Symposium on Biomedical Imaging: From Nano to Macro, pp. 1917-1920, March 2011.
[3] J. M. Costa, “Estimation of tumor size evolution using particle filters,” Journal of Computational Biology, 01 2015.
[4] Z. Wu and S. Li, “Reliability evaluation and sensitivity analysis to ac/uhvdc systems based on sequential monte carlo simulation,” IEEE Transactions on Power Systems, vol. 34, pp. 3156-3167, July 2019.
[5] P. J. Van Leeuwen, H. Knsch, L. Nerger, R. Potthast, and S. Reich, “Particle filters for high dimensional geoscience applications: A review,” Quarterly Journal of the Royal Meteorological Society, vol. 145, 04 2019.
[6] H. Lopes and R. Tsay, “Particle filters and Bayesian inference in financial econometrics,” Journal of Forecasting, vol. 30, pp. 168-209, 01 2011.
[7] C. A. Naesseth, F. Lindsten, and T. B. Schn, “High-dimensional filtering using nested sequential Monte Carlo,” IEEE Transactions on Signal Processing, vol. 67, pp. 4177-4188, August 2019.
[8] J. Zhang and H. Ji, “Distributed multi-sensor particle filter for bearings-only tracking,” International Journal of Electronics-INT J ELECTRON, vol. 99, pp. 239-254, 02 2012.
[9] F. Lopez, L. Zhang, J. Beaman, and A. Mok, “Implementation of a particle filter on a gpu for nonlinear estimation in a manufacturing remelting process,” in 2014 IEEE/ASME International Conference on Advanced Intelligent Mechatronics, pp. 340-345, July 2014.
[10] F. Lopez, L. Zhang, A. Mok, and J. Beaman, “Particle filtering on gpu architectures for manufacturing applications,” Computers in Industry, vol. 71, pp. 116-127, 2015.
[11] L. M. Murray, A. Lee, and P. E. Jacob, “Parallel resampling in the particle filter,” Journal of Computational and Graphical Statistics, vol. 25, no. 3, pp. 789-805, 2016.
[12] A. Varsi, J. Taylor, L. Kekempanos, E. Pyzer Knapp, and S. Maskell, “A fast parallel particle filter for shared memory systems,” IEEE signal Processing Letters, vo. 27, pp. 1570-1574, 2020
[13] M. Bolic, P. M. Djuric, and Sangjin Hong, “Resampling algorithms and architectures for distributed particle filters,” IEEE Transactions on Signal Processing, vol. 53, pp. 2442-2450, July 2005.
[14] M. Bolic, A. Athalye, S. Hong, and P. Djuric, “Study of algorithmic and architectural characteristics of gaussian particle filters,” Signal Processing Systems, vol. 61, pp. 205-218, 11 2010.
[15] R. Zhu, Y. Long, Y. Zeng, and W. An, “Parallel particle phd filter implemented on multicore and cluster systems,” Signal Process., vol. 127, pp. 206-216, October 2016.
[16] F. Bai, F. Gu, X. Hu, and S. Guo, “Particle routing in distributed particle filters for large-scale spatial temporal systems,” IEEE transactions on Parallel and Distributed Systems, Vol. 27, no. 2, pp. 481-493, 2016.
[17] K. Heine, N. Whiteley, and A. Cemgil, “Parallelizing particle filters with butterfly interactions,” Scandinavian Journal of Statistics, vol. 47, no. 2, pp. 361-396, 2020.
[18] S.Sutharsan, T. Kirubarajan, T. Lang, and M. McDonald, “An optimization-based parallel particle filter for multitarget tracking”, IEEE Transactions on Aerospace and Electronic Systems, vol. 48, pp. 1601-1618, APRIL 2012.
[19] A. Varsi, L. Kekempanos, J. Thiyagalingam, and S. Maskell, “Parallelising particle filters with deterministic runtime on distributed memory systems,” IET Conference Proceedings, pp. 11-18, 2017.
[20] O. Demirel, I. Smal, W. Niessen, E. Meijering, and I. Sbalzarini, “Ppf—a parallel particle filtering library,” IET Conference Publications, vol. 2014, 10 2013.
[21] S. Maskell, B. Alun-Jones, and M. Macleod, “A single instruction multiple data particle filter,” in IEEE Nonlinear Statistical Signal Processing Workshop, pp. 51-54, 2006.
[22] J. Thiyagalingam, L. Kekempanos, and S. Maskell, “MapReduce particle filtering with exact resampling and deterministic runtime,” in EURASIP Journal on Advances in Signal Processing, vol. 2017, p. 71, October 2017.
[23] A. Varsi, L. Kekempanos, J. Thiyagalingam, and S. Maskell, “A single smc sampler on mpi that outperforms a single mcmc sampler”, “eprint arXiv:1905.10252, 2019.
[24] M. Arulampalam, S. Maskell, N. Gordon, and T. Clapp, “A tutorial on particle filters for online nonlinear/non-gaussian Bayesian tracking,” Trans. Sig. Proc., vol. 50, no. 2, pp. 174-188, 2002.
[25] J. D. Hol, T. B. Schon, and F. Gustafsson, “On resampling algorithms for particle filters,” in 2006 IEEE Nonlinear Statistical Signal Processing Workshop, pp. 79-82, September 2006.
[26] T. Li, M. Bolic, and P. M. Djuric, “Resampling methods for particle filtering: Classification, implementation, and strategies,” IEEE Signal Processing Magazine, vol. 32, no. 3, pp. 70-86, 2015.
[27] A. Hegyi, L. Mihaylova, R.Boel, and Z. Lendek, “Parallelised particle filtering for freeway traffic state tracking” in 2007 European Control Conference (ECC), pp. 2442-2449, 2007.
[28] K. Emami, T. Fernando, H. H. lu, H. Trinh, and K. P. Wong, “Particle filter approach to dynamic state estimation of generators in power systems,” IEEE Transactions on Power Systems, vol. 30, no. 5, pp. 2665-2675, 2015.
[29] A. Doucet and S. Sncal, “Fixed-lag sequential monte carlo,” in 2004 12th European Signal Processing Conference, pp. 861-864, 2004.
[30] P. D. Moral, A. Doucet, and A. Jasra, “Sequential monte carlo samplers,” Journal of the Royal Statistical Society. Series B (Statistical Methodology), vol. 68, no. 3, pp. 411-436, 2006.
[31] T. L. T. Nguyen, F. Septier, G. W. Peters, and Y. Delignon, “Efficient sequential monte-carlo samplers for bayesian inference,” IEEE Trans-actions on Signal Processing, vol. 64, pp. 1305-1319, March 2016.
[32] K. Petersen, M. Nielsen, and S. Brandt, “A static smc sampler on shapes for the automated segmentation of aortic calcifications,” in Computer Vision—ECCV 2010 (K. Daniilidis, P. Maragos, and N. Paragios, eds.), (Berlin, Heidelberg), pp. 666-679, Springer Berlin Heidelberg, 2010.
[33] X. Luo, T. Kitasaka, and K. Mori, “Manismc: A new method using manifold modeling and sequential monte carlo sampler for boosting navigated bronchoscopy,” in Medical Image Computing and Computer-Assisted Intervention—MICCAI 2011 (G. Fichtinger, A. Martel, and T. Peters, eds.), (Berlin, Heidelberg), pp. 248-255, Springer Berlin Heidelberg, 2011
[34] F. Nielsen, Introduction to HPC with MPI for Data Science. 09 2016.
[35] S. White, N. Verosky, and T. Newhall, “A cuda-mpi hybrid bitonic sorting algorithm for gpu clusters,” in 2012 41st International Conference on Parallel Processing Workshops, pp. 588-589, September 2012.
[36] E. Jeremiah, S. Sisson, L. Marshall Price, R. Mehrotra, and A. Sharma, “Bayesian calibration and uncertainty analysis of hydrological models: A comparison of adaptive metropolis and sequential monte carlo samplers,” Water Resources Research-WATER RESOURCES, vol. 47, 07 2011.
[37] G. Zhu, X. Li, J. Ma, Y. Wang, S. Liu, C. Huang, K. Zhang, and X. Hu, “A new moving strategy for the sequential monte carlo approach in optimizing the hydrological model parameters,” Advances in Water Resources, vol. 114, pp. 164-179, 2018

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. A method for estimating a true state of a physical system, the method comprising:
receiving, from at least one sensor, a measurement of at least one parameter within the physical system, wherein the at least one parameter is related to the true state of the physical system; and
implementing, on a server comprising a distributed memory architecture, a sequential Monte Carlo (SMC) process using a plurality of statistically independent particles and the at least one measured parameter to estimate the true state of the physical system, wherein the distributed memory architecture has a plurality of cores each of which are ranked, and wherein implementing the SMC method comprises:
determining the number of copies of particles required for each particle; and
redistributing copies of particles which are to be duplicated across the distributed memory architecture, wherein the redistributing comprises:
moving the particles which are to be duplicated to the cores having lowest ranks to create gaps in the higher ranked cores using a rotational nearly sort process; and
when the rotational nearly sort process is complete, filling the gaps with the required number of copies of the particles which are to be duplicated using a rotational split process; and
when the rotational split process is complete, filling the remaining gaps in each core using a sequential redistribute process; and
wherein after the redistributing, each of the plurality of cores only has copies of the particles which are to be duplicated and the total number of copies of each particle across the plurality of cores within the distributed memory architecture equals the determined number of copies.

17. The method of claim 16, wherein moving the particles using the rotational nearly sort process comprises:
determining, for each particle to be duplicated, the number of particles in lower ranked cores which are not to be duplicated; and
obtaining, for each particle to be duplicated, an associated binary expression of the number of particles which are not to be duplicated.

18. The method of claim 17, wherein moving the particles which are to be duplicated is an iterative process comprising:
scanning, for each of the particles to be duplicated, a bit of the associated binary expression;
when the scanned bit is equal to one, rotating the associated particle to a lower ranked core; and
repeating in sequence the scanning and rotating steps for each bit.

19. The method of claim 18, wherein the iterative process initially scans a least significant bit of each binary expression and finally scans a most significant bit of each binary expression.

20. The method of claim 16, wherein filling the gaps using the rotational split process comprises:
computing a minimum shift value for each of the particles to be duplicated, wherein the minimum shift value is a value representing the minimum number of shifts each of the particles must take to securely distance itself from the particles in the lower ranked cores; and
computing a maximum shift value for each of the particles to be duplicated, wherein the maximum shift value is a value representing the maximum number of shifts each of the particles may take to end up in a gap.

21. The method of claim 20, wherein computing the minimum shift value associated with a particle to be duplicated comprises summing for each lower ranked core one less than the number of copies which are required of each particle in the lower ranked cores.

22. The method of claim 21, wherein computing the maximum shift value associated with a particle to be duplicated comprises summing the minimum shift value with one less than the number of copies which are required of the associated particle.

23. The method of claim 20, further comprising obtaining, for each particle to be duplicated, an associated binary expression of the minimum shift value and the maximum shift value.

24. The method of claim 23, wherein creating the gaps is an iterative process comprising:
scanning, for each of the particles to be duplicated, a bit of the associated binary expression of the minimum shift value and the maximum shift value;
when both scanned bits are equal to one, rotating the associated particle to a higher ranked core by a number of positions corresponding to the scanned bits; and
repeating in sequence the scanning and rotating steps for each bit.

25. The method of claim 24, further comprising
when only one scanned bit is equal to zero, splitting the number of copies to be duplicated to determine excess duplicates; and
rotating the excess duplicates to a higher ranked core by a number of positions corresponding the scanned bits.

26. The method of claim 16, wherein filling the remaining gaps in each core using a sequential redistribute process comprises duplicating particles within the memory of each core.

27. The method of claim 16, further comprising:
obtaining values for each of the particles;
computing weights for each of the particles, wherein the weight indicates the resemblance of the obtained values to the true state;
normalising the computed weights;
determining the number of copies which are required based on the normalised weights; and
after redistributing the particles, resetting the weights.

28. The method of claim 27, wherein determining the number of copies ncopies i required for each particle i is computed from:
ncopiesⁱ=┌cdfⁱ⁺¹−u┐−┌cdfⁱ−u┐
where cdfⁱ is the cumulative density function of the weights up to and including the i^{th} particle and u is drawn from a uniform distribution with u˜[0,1).

29. The method of claim 16, wherein the SMC process is selected from a particle filter, a fixed-lag SMC sampler and an SMC sampler.

30. An architecture for estimating a true state of a physical system, the architecture comprising:
at least one sensor for measuring at least one parameter within the physical system, wherein the at least one parameter is related to the true state of the physical system; and
a server comprising:
a distributed memory architecture having a plurality of cores, wherein the cores are uniquely identified by a rank and the cores are configured to implement a sequential Monte Carlo (SMC) process on the distributed memory architecture using a plurality of statistically independent particles to estimate the true state of the physical system using the at least one measured parameter, and wherein implementing the SMC process by the cores comprises:
determining the number of copies of particles required for each particle; and
redistributing copies of particles which are to be duplicated across the distributed memory architecture, wherein redistributing comprises:
moving the particles which are to be duplicated to the cores having lowest ranks to create gaps in the higher ranked cores using a rotational nearly sort process; and
when the rotational nearly sort process is complete, filling the gaps with the required number of copies of the particles which are to be duplicated using a rotational split process; and
when the rotational split process is complete, filling the remaining gaps in each core using a sequential redistribute process; and
wherein after the redistributing, each of the plurality of cores only has copies of the particles which are to be duplicated and the total number of copies of each particle across the plurality of cores within the distributed memory architecture equals the determined number of copies.
